(19) United States
(12) Patent Application Publication
(10) Pub. No.: US 2008/0253688 A1
(43) Pub. Date: Oct. 16, 2008

(54) EFFICIENT INTEGRATION OF ROAD MAPS

(75) Inventors: Eliyahu SAFRA, Haifa (IL); Yaron Kanza, Kibbutz Tzuba (IL); Yehoshua Sagiv, Jerusalem (IL); Yerach Doytsher, Raanana (IL)

Correspondence Address: BROWDY AND NEIMARK, P.L.L.C.;624 NINTH STREET, NW, SUITE 300, WASHINGTON, DC, 20001-5303, US

(73) Assignees: Technion Research and Development Foundation Ltd., Technion City (IL); Yissum Research and Development Company of The Hebrew University of Jerusalem, Jerusalem (IL); The University of Toronto, Toronto (CA)

(21) Appl. No.: 12/100,165

(22) Filed: Apr. 9, 2008

Related U.S. Application Data
(63) Continuation-in-part of application No. PCT/IL2007/001376, filed on Nov. 8, 2007.
(60) Provisional application No. 60/857,805, filed on Nov. 9, 2006.

(51) Int. Cl. G06K 9/32

(52) U.S. Cl. 382/294

(57) ABSTRACT

Systems and methods for integrating maps in which roads are represented as polylines. The main novelty of the invention is in using only the locations of the endpoints of the polylines rather than trying to match whole lines. Experiments on real-world data are given, showing that this approach of integration based on matching merely endpoints is efficient and accurate (that is, it provides high recall and precision).

### CROSS-REFERENCE TO RELATED APPLICATIONS

The present application is a continuation-in-part of International Application No. PCT/IL2007/001376, filed Nov. 8, 2007, in which the United States is designated, and claims benefit from the Provisional Application No. 60/857,805, filed Nov. 9, 2006, the entire contents of each and all these applications being hereby incorporated by reference herein in their entirety as if fully disclosed herein.

### FIELD OF THE INVENTION

The present invention relates to systems and methods for integrating a plurality of road maps and in particular to integration of digital road maps in which roads are represented as polylines.

### BACKGROUND OF THE INVENTION

### 1. Introduction

Digital road maps represent electronically a network of roads. They can be used in applications such as finding the shortest route between two given locations, providing an estimation of the time it takes to get from one location to another, identifying points of interest such as restaurants or airports on a map etcetera. Such applications may need to use both spatial and non-spatial properties of roads. Integration of two road maps makes it possible for the applications to use properties of a road that are represented in only one of the maps, and at the same time use properties that are represented only in the other map. For example, consider two road maps of some city. Suppose that only the first road map includes buildings in the city with the roads leading to them while only the second road map includes, for each segment of a road, the direction of the traffic and the speed limit in this segment. Integration is needed for estimating the minimal time it takes to get from a certain building in the city to another building.

In many cases, the efficiency of the integration process is crucial. One case is of applications provided by a Web server that should handle many users concurrently. A second example is of applications that run in devices with a limited processing power, e.g., a hand-held device such as a Personal Digital Assistant (PDA). In these cases, when called by a person walking or driving a car, the applications should provide the answer immediately (say, within a few seconds) otherwise the applications will not be useful for the user.

Several methods for integrating road maps were proposed in the past [Y. Doytsher and S. Filin. The detection of corresponding objects in a linear-based map conflation. Surveying and Land Information Systems, 60(2):117-1128, 2000, Y. Gabay and Y. Doytsher. An approach to matching lines in partly similar engineering maps. Geoinformatica, 54(3):297-310, 2000, V. Walter and D. Fritsch. Matching spatial data sets: a statistical approach. International Journal of Geographical Information Science, 13(5):445-473, 1999.]; however, these methods are not efficient. They are designed for finding answers that are as accurate as possible without taking efficiency into consideration. Hence, these methods require a long computation time and they are not suitable for scenarios where efficiency is crucial, and a reasonable answer must be provided within a few seconds.

There is a need in the industry to provide a solution for integration of two (or more) roadmaps providing a good response within a few seconds.

### SUMMARY OF THE INVENTION

The present invention relates to maps in which roads are represented by polygonal lines (polylines). An integration of two such maps is essentially a matching between pairs of polylines that represent the same road in the two maps. The novelty of the invention is in matching roads based merely on locations of endpoints of polylines rather than trying to match whole lines. There are two important advantages to our approach. First, integration can be done efficiently. Secondly, we want our techniques to be general in the sense that they would not require the existence of any particular property of roads, other than endpoint locations. Differently from other properties, location always exists for objects in spatial databases. Also, locations have the same semantics in different maps, so we can compare them without worrying that we will end up comparing unrelated properties. In particular, we do not even use the topology of the road network. This is because using the topology may increase the complexity of the computation. Furthermore, using the topology can be problematic when information is incomplete. For example, we may need to match an intersection of three roads in one map with an intersection of four roads in a second map, due to the fact that some roads are represented in only one of the maps.

It may seem an easy task to match roads using their endpoint locations. However, this is not the case for the following reasons.

First, locations are not accurate, so usually two maps represent the same real-world entity in two different locations. Second, endpoints may be chosen differently in the two maps and, hence, an endpoint in one map may be located in the middle of a line in the other map. Furthermore, when a road is represented as a polyline rather than as a curve, the representation is just an approximation of the real-world line and, so, the two maps can use different approximations. Third, information might be incomplete so that a road or a segment of a road, in one map, may not appear in the other map, and vice versa.

The present invention thus proposes a method for integrating two digital road maps that matches polylines merely according to the locations of their endpoints. The method is based on finding a partial matching between the endpoints of polylines in the two sources. We discuss two semantics for matching endpoints, namely, the AND semantics and the OR semantics. Under the AND semantics, two endpoints are matched if each one is the nearest neighbors of the other. Under the OR semantics, two endpoints are matched if at least one of the points is the nearest neighbor of the other.

In order to show the efficiency and the effectiveness of our techniques, we conducted experiments on real-world data. In the tests, we compared the AND and the OR semantics. Also, we investigated the effect of computing the matching using only endpoints that satisfy a given condition about the number of roads that intersect them. Our tests show that the proposed integration methods are efficient and accurate, i.e., they provide high recall and high precision. The tests also show that the best performance, in terms of both efficiency and accuracy, is for the AND semantics when using only endpoints that are intersections of three or more roads.

The present invention relates to a method for integrating a plurality of spatial datasets comprising a plurality of topological nodes and polylines, said method comprising the steps of:

(i) finding the topological nodes of each spatial dataset and generating a plurality of pairs, each pair consisting of a topological node and an associated polyline such that said topological node is an endpoint of said associated polyline;

(ii) matching the topological node of each generated pair in said plurality of spatial datasets with another topological node in a generated pair of a different spatial dataset, such that two topological nodes are matched if they represent the same real-world intersection in the corresponding spatial datasets; and

(iii) matching the polylines in said plurality of spatial datasets based on the previously matched topological nodes.

The first step consists of looking at each spatial dataset, and identifying all the topological nodes that are an endpoint of a polyline in the same spatial dataset. When the polyline represents a road, the identified topological nodes represent the beginning of a road and the end of a road.

In the second step, we look at each identified topological node in the pairs, that is a topological node that is an endpoint of an associated polyline, and look for a match that is, a topological node in a pair in a different spatial dataset. The matching is considered successful if the two nodes are deemed to represent the same real world location. In the case of roads, the real world location would be an intersection.

After matching the topological nodes, the result is that some topological nodes have a successful match with a topological node in a different spatial dataset, while some topological nodes may not have any successful match.

In the third step, the polylines in the different spatial datasets are matched based on the previously matched topological nodes. When two topological nodes are matched, their associated polylines are deemed to represent the same road (or any other spatial data contained in the dataset).

When performing multiple integrations (lookouts) of spatial datasets, it is not necessary to perform the first step again, unless the spatial dataset has been updated and contains new data, thus the first step of finding the topological nodes can be carried out in a separate preprocessing operation.

The same real-world location may not be represented exactly as the same point in different spatial datasets, thus when trying to match two topological nodes in two spatial datasets, one needs to take into account the mutual bound error. Two topological nodes are deemed to match if the distance between them is not greater than the mutual bound error.

In one embodiment of the present invention, matching two polylines is successful if one of the following relationships between said two polylines occur:

(i) complete overlap between said two polylines;

(ii) one polylines is an extension of the second polylines;

(iii) one polylines is contained in the second polylines; and

(iv) partial overlap of said two polylines.

In another aspect the present invention relates to a method for integrating two spatial datasets comprising a plurality of topological nodes and polylines representing real-world roads, said method comprising the steps of:

(i) finding the topological nodes of each spatial dataset and generating a plurality of pairs, each pair consisting of a topological node and an associated polyline such that said topological node is an endpoint of said associated polyline;

(ii) matching the topological node of each generated pair in one spatial dataset with another topological node in a generated pair of the other spatial dataset, such that two topological nodes are matched if they represent the same real-world intersection in the corresponding spatial datasets; and

(iii) matching the polylines in the two spatial datasets based on the previously matched topological nodes.

### BRIEF DESCRIPTION OF THE DRAWINGS

FIGS. 1A-1C depict different road end-points and their degree. In FIG. 1A the end points a and b are of degree higher than 2, in FIG. 1B the end points c and d are of degree 2, and in FIG. 1C the end points e and f are of degree 1.

FIG. 2 shows the basic algorithm AproxMatching(x,□a).

FIG. 3 shows the Match-Lines method for matching of the polylines according to the above four relationships depicted in FIG. 4: complete overlap, extension, containment and partial overlap.

FIGS. 4A-4D depict the four relationships between corresponding polylines: complete overlap (FIG. 4A), extension (FIG. 4B), containment (FIG. 4C) and shows partial overlap (FIG. 4D).

FIG. 5 illustrates matching of short lines wherein Line 2-4 will be matched to Line a-b, Line b-c, and Line b-d.

FIG. 6 illustrates dealing with length differences where Line 1-2, which has the shape of a cup (␣), should not be matched to Line a-b due to length differences.

FIG. 7 illustrates another example of dealing with length differences where Line a-b, which has the shape of a tennis racket, should not be considered as contained in Line 1-2 due to length differences.

FIG. 8 illustrates that the interval b-c on Line a-d is the projected part of Line 2-3 on Line a-d.

FIG. 9 shows maps in which node degrees can improve the matching.

FIG. 10 is a map showing fragments of the CUGIR (dashed lines) and LION (solid lines) road maps (Manhattan).

FIG. 11 shows Fragments of the SOI (solid lines) and MAPA (dashed lines) road maps (Tel-Aviv).

FIG. 12 shows a visual view of the vicinity of two junctions (SOI depicted by solid lines and MAPA depicted by dashed lines).

FIG. 13 shows Fragments of the SOI (solid lines) and MAPA (dashed lines) road maps (Haifa).

FIG. 14 is a graph showing recall and precision, considering pairs and singletons (New York).

FIG. 15 is a graph showing recall and precision, considering just pairs (New York).

FIG. 16 is a graph showing recall and precision, considering pairs and singletons (Tel-Aviv).

FIG. 17 is a graph showing recall and precision, considering just pairs (Tel-Aviv).

FIG. 18 is a graph showing recall and precision, considering pairs and singletons (Haifa).

FIG. 19 is a graph showing recall and precision, considering just pairs (Haifa).

FIG. 20 is a graph showing recall and precision, when dealing with anomalies (Haifa).

FIG. 21 is a graph showing recall and precision, when dealing with anomalies considering only pairs (Haifa).

FIG. 22 shows an example where Line 1-3 and Line a-c can be considered either as two or as three pairs.

FIG. 23 shows an example where adding nodes may reduce the recall.

FIG. 24 shows an example of uncertainty of nodes because the location of Junction 1 is imprecise.

FIG. 25 shows an example of uncertainty of nodes because Imprecision leads to matching both Line a-b and Line a-c to Line 1-3.

FIG. 26 is a graph demonstrating the effect of changing the threshold on the integration of the datasets, showing time versus threshold (New-York).

FIG. 27 is a graph demonstrating the effect of changing the threshold on the integration of the datasets, showing Harmonic Mean of Recall and Precision (HRP) versus threshold (New-York).

FIG. 28 is a graph demonstrating the effect of changing the threshold on the integration of the datasets, showing time versus threshold (Tel-Aviv).

FIG. 29 is a graph demonstrating the effect of changing the threshold on the integration of the datasets, showing HRP versus threshold (Tel-Aviv).

FIG. 30 is a graph demonstrating the effect of changing the threshold on the integration of the datasets, showing time versus threshold (Haifa).

FIG. 31 is a graph demonstrating the effect of changing the threshold on the integration of the datasets, showing HRP versus threshold (Haifa).

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

### 2. Framework

In this section we present our framework. We provide formal definitions to the notion of a road map in a geo-spatial database. Also, we discuss the notation of a matching algorithm and we describe the result of such an algorithm.

### 2.1 Road Map

A road map represents a network of real-world roads, using nodes and edges. The nodes (also called topological nodes) are either intersections, where two or more roads meet, or road ends where roads terminate without intersecting another road. The edges are road objects. Note that under this interpretation, a road may start or end at an intersection, but never includes an intersection as an intermediate point.

A road object is represented by a polygonal line (abbreviated herein polyline). A polyline is a continuous line composed of one or more line segments, such that every two consecutive segments intersect only in their common endpoint while non-consecutive segments do not intersect. In some places, where it is clear from the context, we use the term line for a polyline. Formally, a polyline l is a sequence of points p₁, . . . , pₙ. Every two successive points pᵢ and pᵢ₊₁, in the sequence, define a segment of the polyline. The points p₁ and pₙ are the endpoints of l. As noted earlier, the endpoints are the nodes of the road map. The degree of a node p is the number of polylines that have p as one of their endpoints.

A road map is a geo-spatial dataset that consists of spatial objects (i.e., road objects) representing real-world roads. Several objects may represent different parts of the same real-world road, e.g., each lane in a highway could be represented by a different object. Also, an object may represent more than one real-world road. An object has associated spatial and non-spatial attributes. Spatial attributes describe the location, length, shape and topology of a road. Examples of non-spatial attributes are road number, traffic direction, number of lanes, speed limit, etc.

### 2.2 Matching Corresponding Objects

The main task in integration of spatial datasets is identifying pairs of corresponding objects. Corresponding objects are objects that represent the same real-world entity in distinct sources. In road maps, corresponding objects are polylines that represent the same road. The corresponding objects should be joined in the integration. Yet, some objects may represent in one dataset a real-world entity that is not represented in the other dataset. Such objects should not be joined with any object, and thus, should not appear in any pair of corresponding objects.

We represent by join sets objects that should be joined. Given two datasets, a join set is one of the following two. (1) A pair of corresponding objects. (2) A single object that has no corresponding object in the other set. We call the set of all join sets a matching of the spatial objects. The goal of a matching algorithm is to find a matching.

In many practical cases, there are no global identifiers that can tell whether two objects are corresponding objects. Hence, we must settle for an approximation when computing a matching. An approximated matching is computed according to the properties of the spatial objects. In our approach, we compute matchings based on the location of objects. This is because locations are always available for spatial objects. Also, comparing locations can be done efficiently, thus, using locations complies with our goal of having an efficient algorithm.

Using locations for computing a matching of polylines is not always easy. First, locations are not accurate. Thus, the same road may have different locations in different sources. Secondly, a polyline is represented by more than one point. Furthermore, two polylines that represent the same road may not have the same number of segments. So, there is no straightforward way of comparing all the locations of the points of two polylines for testing whether the polylines are corresponding objects. In our approach, we solve this difficulty by applying a test that is based merely on the location of the endpoints of the polylines.

We propose a twofold integration process. Initially, a matching of the nodes is computed. Then, a matching of the polylines is generated based on the matching of the nodes. In the first phase, we say that two nodes are corresponding if they represent the same real-world intersection (or road end) in the two given maps. Each node has a point location. Hence, an existing algorithm [C. Beeri, Y. Doytsher, Y. Kanza, E. Safra, and Y. Sagiv. Finding corresponding objects when integrating several geo-spatial datasets. In ACM-GIS, pages 87-96, 2005, C. Beeri, Y. Kanza, E. Safra, and Y. Sagiv. Object fusion in geographic information systems. In VLDB, pages 816-827, 2004.] can compute an approximate matching of the nodes, based on their point locations. In principle, the join sets computed in this phase consist of either two corresponding nodes or a single node that has no corresponding node in the other source. However, the second phase uses only the join sets that have two corresponding nodes in order to compute a matching of the polylines.

### 2.3 Error Bound

In an integration process, the accuracy of the given datasets must be taken into account. Object locations are never completely accurate. The accuracy of locations is influenced by several factors, such as the techniques used to measure locations, the precision of the locations in the dataset (i.e., the number of digits used for storing them) and so on. The errors in the locations of spatial objects are normally distributed, with a standard deviation σ and a mean that is equal to zero. We measure the accuracy of a dataset in terms of the error factor m. In the implementation described herein, we assume that m is 2.5σ. When m=2.5σ, for 98.8% of the objects in the dataset, the distance between each object and the real-world entity that it represents is less than or equal to m.

Given two datasets with error factors m₁ and m₂, their mutual error bound is β=\sqrt{m₁²+m₂²}. The mutual error bound is the expected maximal distance between corresponding objects. Its meaning is similar to that of the error factor. That is, in 98.8% of the cases, the distance between pairs of corresponding objects is less than or equal to β.

In our algorithms, the standard deviation σ of each dataset is provided. The error bound β is computed and pairs of objects are candidates for being corresponding objects only if the distance between them does not exceed β.

### 3. Computing a Matching

We now present our algorithms for computing a matching of polylines. The algorithms receive as input two datasets, M₁ and M₂, consisting of polylines. The output is an approximate matching of the polylines. Computing the matching is a three-step process. In the first step, the algorithms find the topological nodes and generate all pairs consisting of a node and a polyline, such that the node is an endpoint of the polyline. In the second step, a matching of the nodes is computed. Finally, the matching of the polylines is generated. In this section, we discuss the details of these steps.

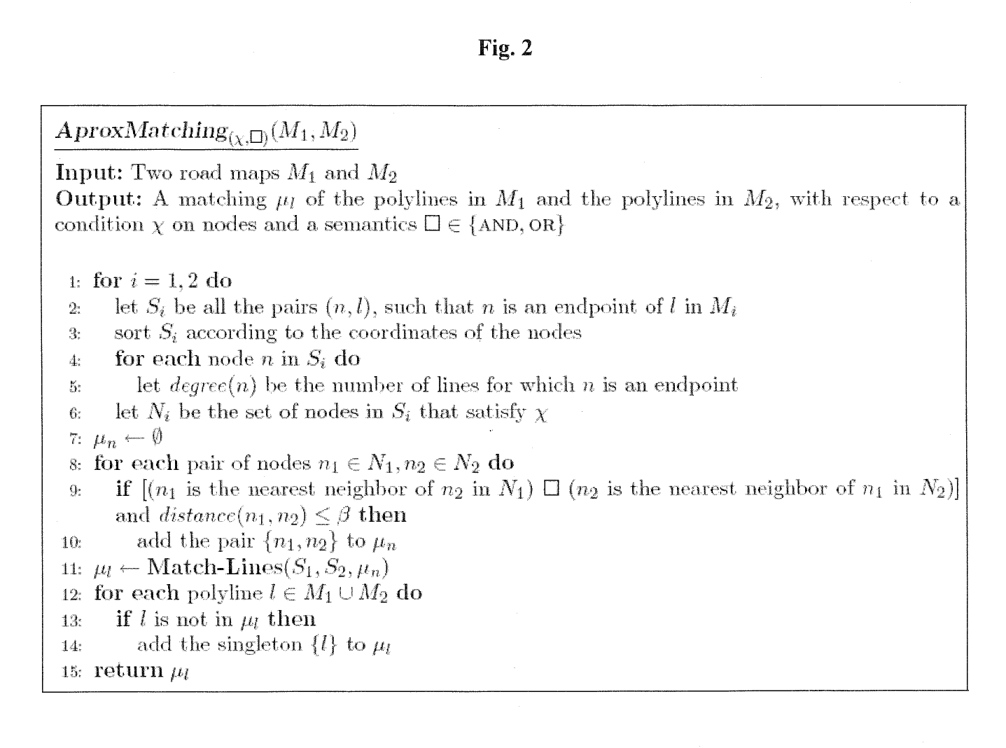

We propose several algorithms that are obtained from one basic algorithm by choosing (in the first step) a condition for selecting topological nodes and determining (in the second step) a semantics for computing a matching of the selected nodes. The basic algorithm AproxMatching(x,□) is presented in FIG. 2. Under the AND-semantics, □ should be replaced with the and logical operator, i.e., conjunction; and under the OR-semantics, □ should be replaced with the or logical operator, i.e., disjunction. Variations of the basic algorithm are also obtained by considering as nodes only endpoints that satisfy a given condition X. Possible conditions and their effect are discussed in the following section.

### 3.1 Finding the Topological Nodes

In the first step, the condition X is applied in order to find the topological nodes that will be matched in the second phase. The condition X selects one of the following three sets of nodes: all intersections of at least three roads, all intersections of at least three roads as well as all nodes where only one road object ends, and all the nodes (including nodes where only two roads meet). The following three conditions express these options.
1. Condition I: The node degree is greater than 2.
2. Condition II: The node degree is different from 2, i.e., is either equal to 1 or greater than 2.
3. Condition III: The node degree is any number.

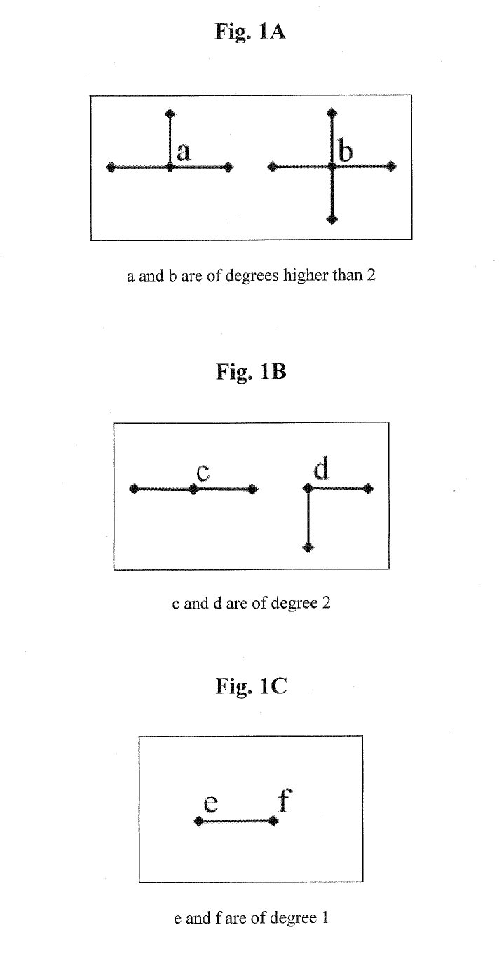

Example 3.1. In FIGS. 1A-1C, roads and end-points are depicted. In FIG. 1A the end points a and b are of degree higher than 2 (a is of degree 3 and b is of degree 4), in FIG. 1B the end points c and d are of degree 2, and in FIG. 1C the end points e and f are of degree 1. Nodes a, b, e and f satisfy Condition II since their degree is different than 2.

The step of finding the relevant nodes, of each dataset Mᵢ, is presented in Lines 1-6 of the algorithm of FIG. 2. First, for each polyline l in Mᵢ, where n and n′ are the endpoints of l, the pairs (n, l) and (n′, l) are added to the set Sᵢ. Then, the set Sᵢ is sorted according to the coordinates of the nodes. The sort makes it possible to compute the degree of each node and discard nodes that do not satisfy X, in a single pass over Sᵢ. Note that the step of finding the topological nodes can be done as a preprocessing in each source separately. Also, it can be computed in parallel for the two sources.

### 3.2 Matching Nodes

In the second step, the algorithms compute an approximate matching μₙ over the nodes of the sets N₁ and N₂ obtained in the first step. The approximation depends on the chosen semantics. Under the AND-semantics, i.e., when □ is and, the algorithm finds all pairs of nodes n₁εN₁ and n₂εN₂, such that n₁ is the nearest neighbor of n₂ in N₁ and n₂ is the nearest neighbor of n₁ in N₂. The set of all such pairs is added to μₙ. This approach of matching mutually nearest objects was investigated in the past and is called the mutually nearest method [C. Beeri, Y. Doytsher, Y. Kanza, E. Safra, and Y. Sagiv. Finding corresponding objects when integrating several geo-spatial datasets. In ACM-GIS, pages 87-96, 2005, C. Beeri, Y. Kanza, E. Safra, and Y. Sagiv. Object fusion in geographic information systems. In VLDB, pages 816-827, 2004.]. Note that under the AND-semantics, each node appears in exactly one pair of corresponding objects.

Under the OR-semantics, i.e., when □ is or, the matching μₙ that the algorithm computes consists of all pairs n₁εN₁ and n₂εN₂, such that either n₁ is the nearest neighbor of n₂ (in N₁) or n₂ in the nearest neighbor of n₁ (in N₂). Note that under the OR-semantics, a node may appear in more than one pair of corresponding objects.

When matching nodes, we must take into account the error factors of the given datasets. A pair of objects that are “too far” from each other cannot be corresponding. Hence, we compute the mutual error bound β of the sources (see Section 2.3) and under both the AND and the OR semantics, we discard from μₙ all pairs of nodes, such that the distance between them is greater than β.

### 3.3 Matching Polylines

In the third and final step, the algorithms compute the matching of the polylines from the matching μₙ of the nodes. First, pairs of corresponding polylines are found by the method Match-Lines (Line 11 of FIG. 2). Then, singletons are created from all the remaining polylines (Lines 12-14 of FIG. 2).

We define four types of spatial relationships between polylines and we consider polylines as corresponding if one of these four relationships occurs. Consider two polylines l₁ and l₂, each from a different source. Let n₁ and n′₁ be the endpoints of l₁, and let n₂ and n′₂ be the endpoints of l₂. The four types of relationships, which are considered as correspondence, are the following.
1. Complete overlap: We say that there is a complete overlap for l₁ and l₂ if they have two pairs of corresponding endpoints, e.g., the pairs {n₁, n₂} and {n′₁, n′₂} are corresponding nodes.
2. Extension: We say that l1 extends l2 when l₁ and l₂ have a pair of corresponding endpoints, and the other endpoint of l₂ is an intermediate point in l₁, e.g., {n₁, n₂} are corresponding nodes and n′₂ is an intermediate point in l₁.
3. Containment: We say that l₁ contains l₂ when both endpoints of l₂ are intermediate points of l₁.
4. Partial overlap: We say that there is a partial overlap for l₁ and l₂ if each of them has an intermediate point in the other, e.g., the node n₁ is an intermediate point in l₂ and the node n′₂ is an intermediate point in l₁.

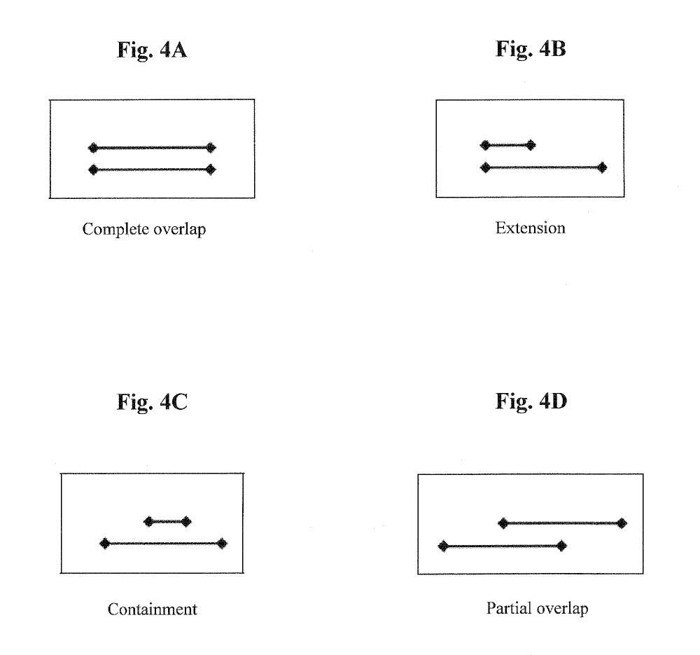

Example 3.2. The four relationships between corresponding polylines are depicted in FIGS. 4A-4D. FIG. 4A illustrates two roads with complete overlap, FIG. 4B illustrates two roads where one is an extension of the other, FIG. 4C illustrates containment where one road is contained in the other road, and FIG. 4D shows partial overlap where one road partially overlaps the other road.

We denote by in(n, l) a predicate that is satisfied when n is an intermediate point in l and is false otherwise. In practice, we use an approximation when testing whether a node is an intermediate point in a polyline. Given n and l, let n′ be the nearest point to n on l. Let β be the mutual error bound of the datasets, as discussed in Section 2.3. Then, in(n, l) returns true if the distance between n and n′ is not greater than β. When l contains a single segment, n′ can be found by applying an orthogonal projection of n on l.

When l is made of more than one segment, first, the nearest point to n in each one of the segments can be computed by applying an orthogonal projection of n on these segments. Then, n′ is the point with the shortest distance from n among the points found by the orthogonal projections.

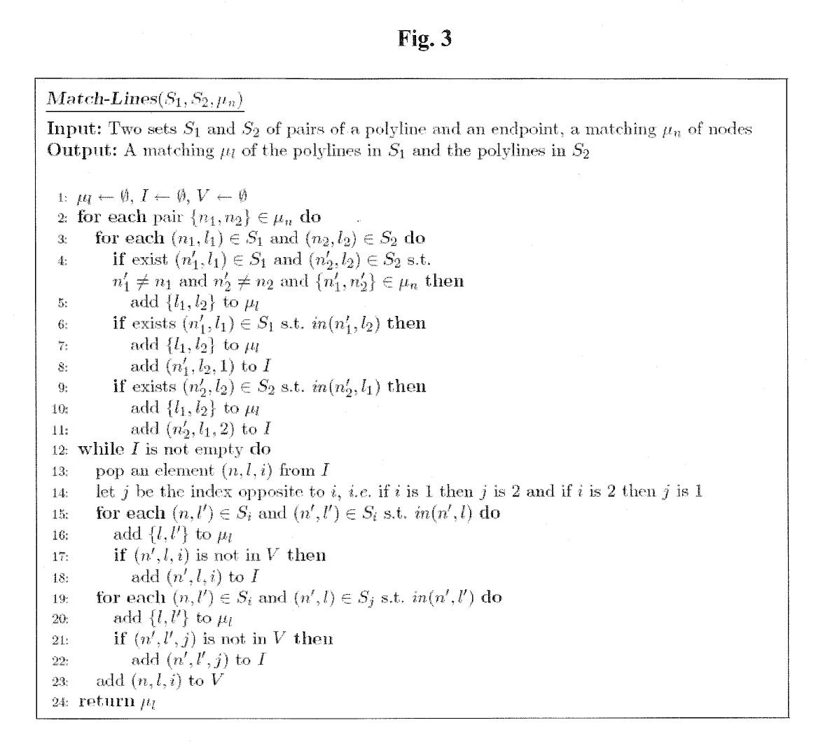

The matching of the polylines according to the above four relationships is computed by the method Match-Lines presented in FIG. 3. The method receives polylines, their endpoints (the sets S₁ and S₂) and a correspondence relationship μₙ for the nodes. It returns a set μiₙ consisting of pairs of corresponding polylines.

The method uses two supporting data structures. A stack I is used for storing triplets of a polyline, a node whose location is an intermediate point in the polyline and the index of the source from which the node is taken. A list V is used for storing triplets as those stored in I for the purpose of recording which triplets have already been visited in the traversal of the algorithm over the nodes.

The method Match-Lines tests the existence of relationships between polylines. In Lines 2-11, it finds lines that have a complete overlap or an extension relationship. In the case of a complete overlap, the pair of lines is simply added to μᵢ (Lines 4-5). In the case of an extension, the pair of lines is added to μₗ and, in addition, the triplet for the line and the node, where the node is an intermediate point in the line, is added to I (Lines 6-11).

In Lines 12-22, the algorithm tries to find pairs of polylines that have a containment or a partial-overlap relationship: containment is dealt with in Lines 15-18 and partial overlap in Lines 19-22. In a run of the algorithm, when Line 12 is reached, I already contains the intermediate points that were discovered during the search for lines having the extension relationship. When new intermediate points are discovered, they are added to I. The list V is used for recording which intermediate nodes were already visited, as part of a bookkeeping intended to make sure that we do not process the same intermediate node more than once. Note that Match-Lines may not discover all the lines that have a containment or a partial-overlap relationship. This is because in the traversal over the nodes, the algorithm will not visit intermediate nodes that are isolated, that is, intermediate nodes that are not connected by an edge to a visited node. This was done on purpose, since our goal is to provide an approximate matching while keeping the algorithm efficient.

### 3.4 Data Structures

In order to improve the efficiency of the computation, two auxiliary data structures, in addition to I and V, were employed in the implementation of Match-Lines. One data structure, denoted Lₚₒᵢₙₜ, provides for each point a list that contains all the polylines having this point as one of their endpoints. The second data structure, denoted L_{polyline}, stores for each polyline its two endpoints.

The two data structures are implemented as a Vector. (A Vector is similar to an array except that its size can grow.) The nodes in the input datasets are mapped to the numbers 1, 2, 3, . . . —each node to a unique arbitrary number. Hence, a pointer to the list, of polylines that have some Node i as their endpoint, can be retrieved in O(l) time complexity by directly accessing the i-th entry in Lₚₒᵢₙₜ. Polylines are mapped to numbers in a similar way, so retrieving the endpoints of a polyline from L_{polyline} is the same as the access to Lₚₒᵢₙₜ, and it is also being done in O(l).

3.5 Dealing with Length Anomalies

There are two anomalous cases in which matching polylines based on merely the matching of the end-points is problematic. In this section, we present these two cases, which we have encountered during our experiments. Also, we explain how our algorithms can be easily modified to deal with these cases. In fact, the anomalies we consider in this section are quite rare in all the datasets we tested. Thus, our algorithms are accurate even without the modifications hereafter. We will discuss the effect of these modifications on the accuracy of the algorithm in Section 5.

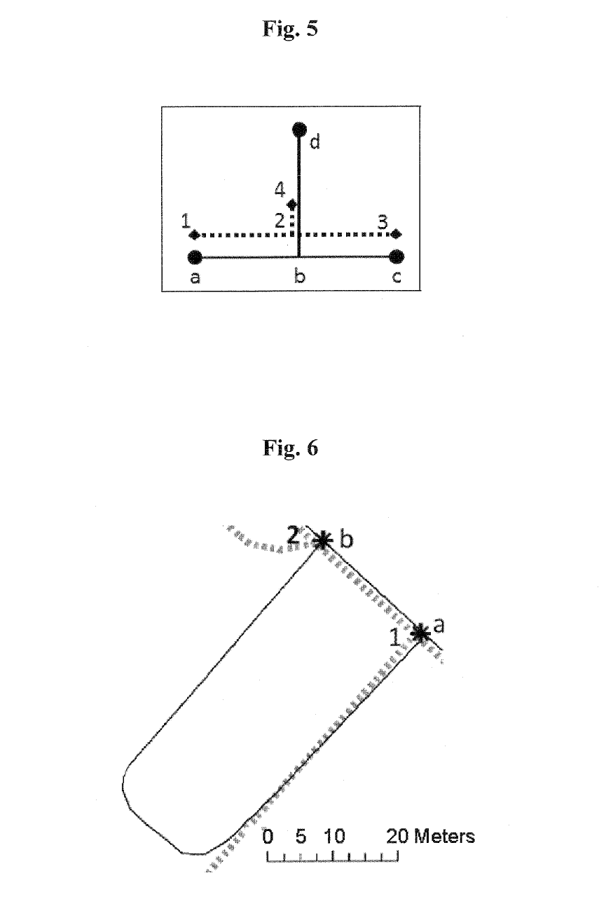

3.5.1 Short lines. The first anomaly we encountered is due to short lines. We say that a polyline is short if its length is smaller than the error bound of its source. When the two endpoints of a short line l are near some intersection X of polylines, it may happen that the two endpoints of l will be considered as intermediate points of several polylines that intersect in X. If this happens, l may be matched to lines that have different orientations. Users often consider such matching as an error. For example, consider the roads in FIG. 5. Suppose that Line 2-4 (i.e. the line between Point 2 and Point 4) is a short line. In this case, Point 2 and Point b will be considered corresponding objects. Point 4 will be considered an intermediate point on each of the three lines: Line a-b, Line b-c, and Line b-d. Thus, Line 2-4 will be deemed as contained in all the three lines-Line a-b, Line b-c, and Line b-d. Yet, we would like that Line 2-4 will only be considered as contained in Line b-d.

For correctly handling short lines, we define for each short line a new error bound that is equal to half of the length of the short line. Then, we compute for each pair of a line and a short line, a new mutual-error bound. For instance, if we try to match a line l₁ from a source having error factor m1 with a short line l₂, the mutual-error bound of the two lines will be

$$β \sqrt{{m}_{1}^{2} + {( \frac{length ( {l}_{2} )}{2} )}^{2}}$$

As we discussed earlier, if an endpoint n of l₂ has a distance from l1 that is greater than β, then n cannot be an intermediate point of l₁. This helps assuring that matched lines will have the same orientation, while avoiding complex geometric computations. If, for example, we will use this approach in the case presented in FIG. 5, then Point 4 will only be considered an intermediate point of Line b-d.

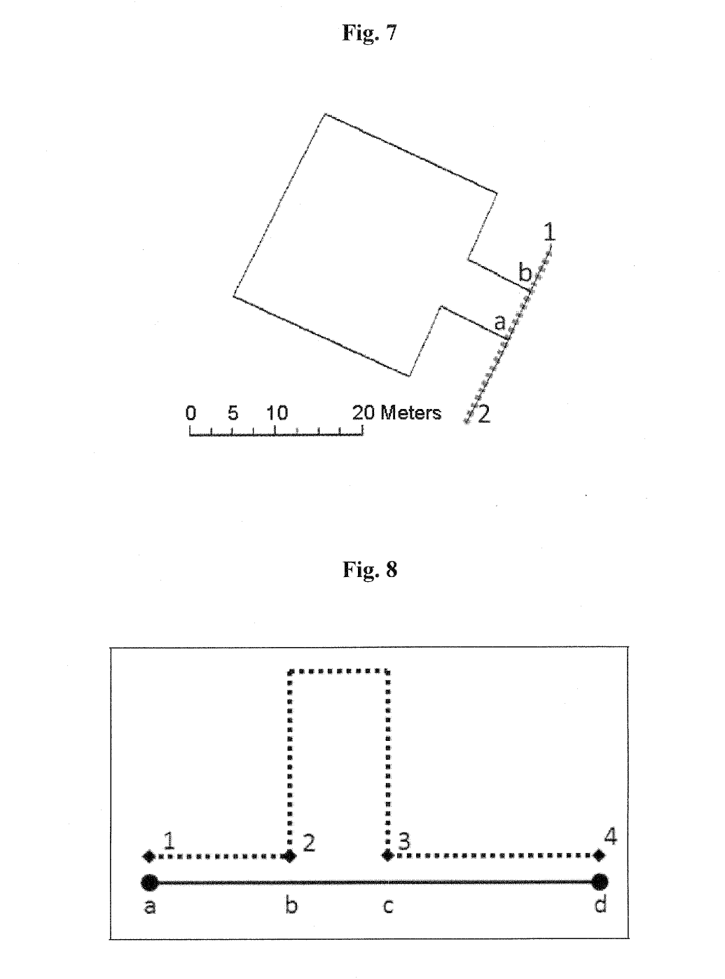

3.5.2 Length differences. The second special case we encountered is when two polylines have the same endpoints, yet, the curvature of the lines is different. This happens, for instance, when one polyline is straight while the other is curved. For example, in FIG. 6, Line a-b goes straight from Point a to Point b while Line 1-2 connects the points in a curved route and, thus, is much longer than Line a-b. When considering only the endpoints, our algorithm will assert that the two lines are corresponding. However, many people will consider this assertion as an error. A similar error may occur when trying to match a straight line to a curved line where one or both of the endpoints, of the curved line, are intermediate points on the straight line (see an example in FIG. 7).

In order to discover anomalies of this type, we compare the lengths of matched lines. If the ratio of the lengths (the length of the shorter line divided by the length of the longer line) is below some threshold t, then the two lines are not considered corresponding. We tested several threshold values and found that t=0.5 effectively discarded incorrect matches without discarding correct matches. Note that when the endpoints of one line are intermediate points of the other line, we use the length of projecting the first line onto the second to avoid the erroneous assertion of a containment relationship. An example of such a projection is depicted in FIG. 8, where Point 2 and Point 3 are intermediate points of Line a-d, and hence, we divide the length of the projection of Line 2-3 onto Line a-d by the length of Line a-d.

Discovering short lines or length differences requires knowing the lengths of lines; however, in many geo-spatial information systems, the length of each line is computed once and then stored in the system. Thus, in order to apply our techniques for dealing with length anomalies there is no need to apply complex geometric computations, and there is no significant influence on the efficiently of the algorithms.

### 3.6 Using Node Degrees for Improving the Algorithms

In section 4.2, we discussed the discovery of corresponding nodes, and we considered methods that are based merely on the locations of the nodes. However, (E. Safra, Y. Kanza, Y. Sagiv, and Y. Doytsher. Integrating Data from Maps on the World-Wide Web. In W2GIS 2006, pages 180-191) showed that combining locations with additional information, when computing a matching, may improve the quality of the result. The degree of nodes in the road network is such information. We can simply filter out, from the matching of the nodes, pairs of nodes whose degrees differ one from the other. Note that such filtering does not affect the generality of our approach. We will later show that the filtering may improve the quality of the result and increase the efficiency of the computation.

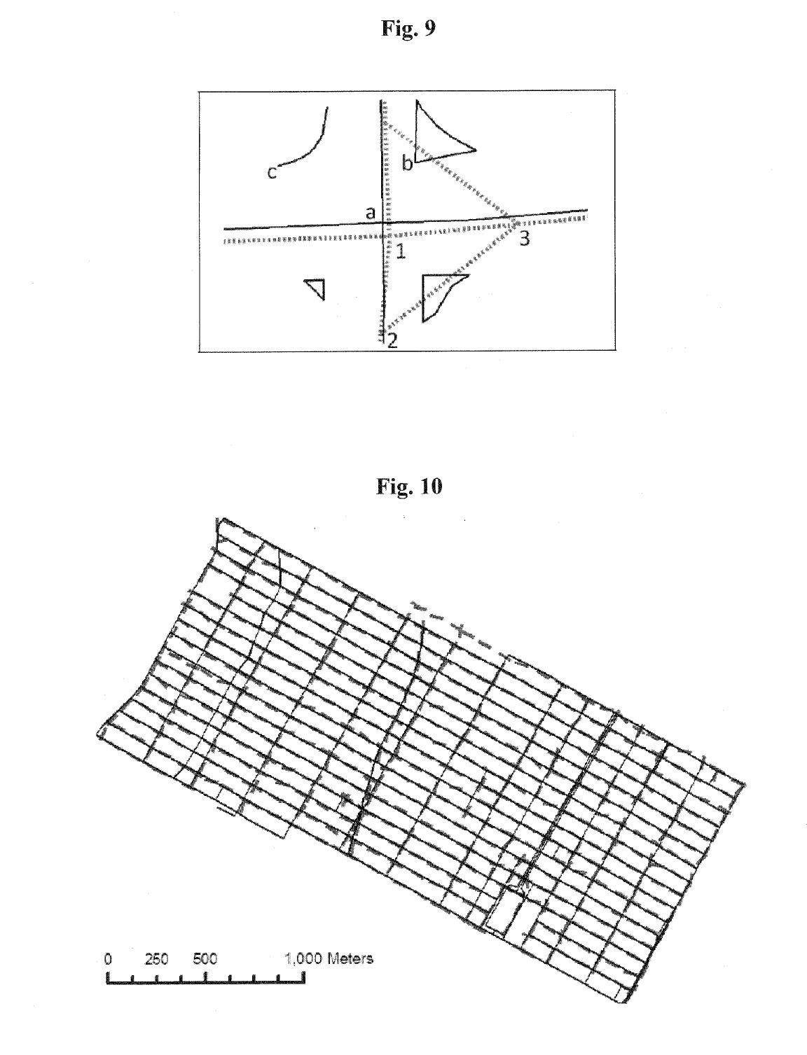

The filtering step is illustrated in the following example. FIG. 9 shows two maps that contain several nodes having different degrees. In these maps, only the two nodes whose degree is four (Node a and Node 1) should be matched. Thus, we would like the algorithm to discard matches such as the matching of Node b and Node 1. Note that such matching may occur when using the or-semantics.

Since data sources are sometimes heterogeneous and may represent incomplete information, we allow some level of flexibility in the removal of matchings. To do so, we let users provide a threshold, and we discard from the matching only pairs of nodes that the difference between their degrees exceeds the threshold. The threshold should be chosen according to the heterogeneity of the sources.

Removing pairs of nodes during the first step of the algorithm affects both the efficiency of the algorithm and the accuracy of the result. The removal decreases the number of matchings that the algorithm needs to examine and thus reduces the running time of the algorithm. Therefore, efficiency is improved. If most of the discarded pairs are erroneous matches, the removal increases the accuracy of the algorithm since it improves the accuracy of the first step. Obviously, a removal of correct pairs may reduce the accuracy.

### 3.7 Time and Space Complexity

In this section, we analyze the time and space complexities of the method AproxMatching(x,□). Suppose that the input consists of two road maps M₁ and M₂, and let k₁ and k₂ be the number of polylines in M₁ and M₂, respectively. Note that in this case, the number of nodes in M₁ is at most 2k₁ and in M₂ it is at most 2k₂.

In the first step of the algorithm (i.e., finding the topological nodes), all the operations, except for the sort, have a linear time complexity in the size of the input. Thus, the time complexity of the first step is O(k₁ log k₁+k₂ log k₂), which is the complexity of the sort. The space complexity is O(k₁+k₂).

When computing the matching of the nodes, the nearest-neighbor function is used. Suppose that we use an implementation, of the nearest-neighbor function, that has the following time and space complexities. For a given point and a set of k points, the function finds the nearest neighbor of the point in time complexity Tₙₙ(k) and in space complexity Sₙₙ(k). Then, under the AND-semantics, the time complexity of matching the nodes is either O(k₁Tₙₙ(k₂)) or O(k₂Tₙₙ(k₁)), depending on the dataset that we iterate on. The space complexity is O(min{k₁, k₂}+Sₙₙ(k₁)+Sₙₙ(k₂)), since the number of mutually nearest neighbors is at most min{k₁, k₂}. Under the OR-semantics, the time complexity is O(k₁Tₙₙ(k₂)+k₂Tₙₙ(k₁)). The space complexity is O(k₁+k₂+Sₙₙ(k₁)+Sₙₙ(k₂)), since the number of pairs in which one node is the nearest neighbor of the other is at most k₁+k₂−1.

For the part of computing the matching of the polylines, a rough estimation of the time complexity is O((k₁k₂)² log(|μₙ∥)), where |μₙ| is the number of corresponding nodes, which is at most minfk₁; k₂g under the AND-semantics and k₁+k₂−1 under the OR-semantics. The space complexity is O(k₁+k₂) under both semantics, because of the data structures that the algorithm maintains.

For a finer estimation of the time complexity of the method Match-Lines, we assume that d is the maximal degree of nodes in M₁ and M₂. First, we analyze the complexity of testing overlap and extension. In the test, sets of polylines with a shared node are matched against sets of polylines that also have a shared node, where the sets are from different sources and the shared nodes are corresponding nodes. Each such matching attempt is over two sets whose size is not greater than d. These matching attempts are done for each pair of corresponding objects. The number of corresponding objects is the size of the set μₙ. Hence, the time complexity of testing overlap and extension is O(d²|μₙ|).

When containment and partial overlap are tested, nodes are popped out of I iteratively—each node at most once. Recall that there are at most 2(k₁+k₂) nodes in M₁ and M₂. Then, no more than d edge tests are conducted with respect to each popped node. Retrieving the edges that the popped node is their endpoint can be done in time logarithmic in the sizes of the sets S₁ and S₂. Thus, the time complexity for these tests is O(k₁(log k₂+d)+k₂(log k₁+d)). Preventing the algorithm from processing the same triplet twice is by checking whether the triplet is in V before inserting it into I. There are at most 2(k₁+k₂) elements in V, so this test has O(log(k₁+k₂)) time complexity.

The following proposition summarizes the analysis of the time and space complexities.

Proposition 3.3. Let M₁ and M₂ be road maps containing k₁ and k₂ polylines, respectively, and suppose that k₁, k₂.

1. When called with M₁ and M₂, the time complexity of the method AproxMatching(X;AND) is O(k₁(log k₁+d)+k₂d²+min{k₁Tₙₙ(k₂); k₂Tₙₙ(k₁)}):

2. The time complexity of AproxMatching(X;OR) on M₁ and M₂ is O(k₁(log k₁+d²)+k₁Tₙₙ(k₂)+k₂Tₙₙ(k₁)):

3. The space complexity of both methods is O(k₁+Sₙₙ(k₁)).

### 4. Measuring the Quality of the Results

As in information retrieval, we measure the quality of a matching algorithm in terms of recall and precision. In this section, we discuss four measures of recall and precision that we used in our experiments.

The basic definition of recall and precision measures the rate of correct join sets. Recall is the percentage of correct sets that actually appear in the result (e.g., 87% of all the correct sets appear in the result). Precision is the percentage of correct sets out of all the sets in the result (e.g., 92% of the sets in the result are correct).

Consider an integration of two maps. C denotes the set of correct join sets appearing in the result. A is the set of all the correct join sets. R is the set comprising all the sets in the result. Then, in the basic definition, the recall is

$$\frac{\vert C \vert}{\vert A \vert}$$

and the precision is

$$\frac{\vert C \vert}{\vert R \vert} .$$

An alternative measure, called pair count, is that of counting only pairs and ignoring singletons. Suppose the Cp, Ap and Rp are obtained by discarding the singletons from C, A and R, respectively. Then, the recall is

$$\frac{\vert {\hat{C}}_{p} \vert}{\vert {{A}_{.}}_{p} \vert}$$

and the precision is

$$\frac{\vert {\hat{C}}_{p} \vert}{\vert {{R}_{.}}_{p} \vert} .$$

The pair-count measure should be used when the quality of the result depends only on the number of pairs that were matched. The basic definition should be used when correctly identifying the singletons is significant. For instance, consider an integration of an old map and a new map. It is likely that a road, in the new map, that does not have a corresponding road in the old map, is a new road. If it is important to know which roads are new, one should use a method that is accurate according to the basic measure.

There are cases where we want methods to be influenced by the lengths of the polylines that are matched: a pair of long roads should have a greater influence on the recall and precision than a pair of short roads. In such cases, we use length-based recall and precision. The length of a pair of polylines is defined as the length of the overlapping part of the polylines. For a singleton, the length of the set is the length of the single object. Then, in the basic length-based measure, the recall r and the precision p are

$$r = \frac{{\sum }_{s ∈ C} length ( s )}{{\sum }_{s ∈ A} length ( s )} p = \frac{{\sum }_{s ∈ C} length ( s )}{{\sum }_{s ∈ R} length ( s )} . \qquad ( 1 )$$

A fourth measure is obtained by using Cₚ, Aₚ and Rₚ instead of C, A and R, respectively, in Equation 1.

By and large, methods that provide high recall and precision according to length-based measures are good for integrating road maps of rural areas, i.e., maps where long roads are more important than short roads. Methods that provide high recall and precision in measures based on counting join sets are suitable for integrating road maps of urban areas, i.e., maps that contain many short roads and the importance of a road does not depend on its length.

In our tests, we used all the four measures for comparing our methods with the result of an integration performed by a human expert. That is, we considered the set A of all the correct join sets to be the join sets found by the expert, and we computed our measures with respect to this set.

### 5. Experiments

In this section, we describe our experiments for determining the efficiency and accuracy of the six variants of the basic algorithm AproxMatching(X,□) of FIG. 2. We use AND and OR to denote the two semantics of Section 3.2 for matching nodes. The numerals 1, 2 and 3 indicate the three conditions of Section 3.1 that determine the nodes participating in the matching process. Altogether, we tested six algorithms; for example, “AND 1” denotes the algorithm that selects the nodes according to the first condition (i.e., the degree is greater than 2) and uses the AND-semantics for matching them.

The experiments were aimed at showing the efficiency and the accuracy of our algorithms, and in particular answering the following three questions.

(i) Which of the three conditions of Section 3.1 is best for selecting nodes?

(ii) Which of the two semantics of Section 3.2 gives better results?

(iii) What is the effect of the improvements that were discussed in Section 3.5 and in Section 3.6.

We considered both questions with respect to the different ways of measuring the quality of the result (i.e., length vs. sets).

### 5.1 Input Datasets

In our experiments we used real-world datasets from maps of three different cities: New-York City (New York, USA), Tel Aviv (Israel) and Haifa (Israel). Tel Aviv and New York are located in relatively flat areas while Haifa resides in a hilly area. The different datasets were collected by different organizations, at different times and using different collection methods.

5.1.1 New-York datasets. We used two maps of New-York in our tests. The first map is published on the World-Wide Web by the Department of City Planning of New-York (available at http://www.ci.nyc.ny.us/html/dcp/home.html) and we refer to this dataset as LION. The Web site does not specify the accuracy of this map. Yet, it does say that the accuracy of the data in LION has been gained by spatially aligning the features of the map with an aerial photography.

The second map we used was taken from Cornell University Geospatial Information Repository (available at http://cugir.mannlib.cornell.edu). We refer to this dataset as CUGIR. The source of the data in CUGIR is The Census TIGEG (Topologically Integrated Geographic Encoding and Referencing) database. The accuracy level of CUGIR complies with the standard of the U.S. Geological Survey (USGS) for 1:100,000-scale maps.

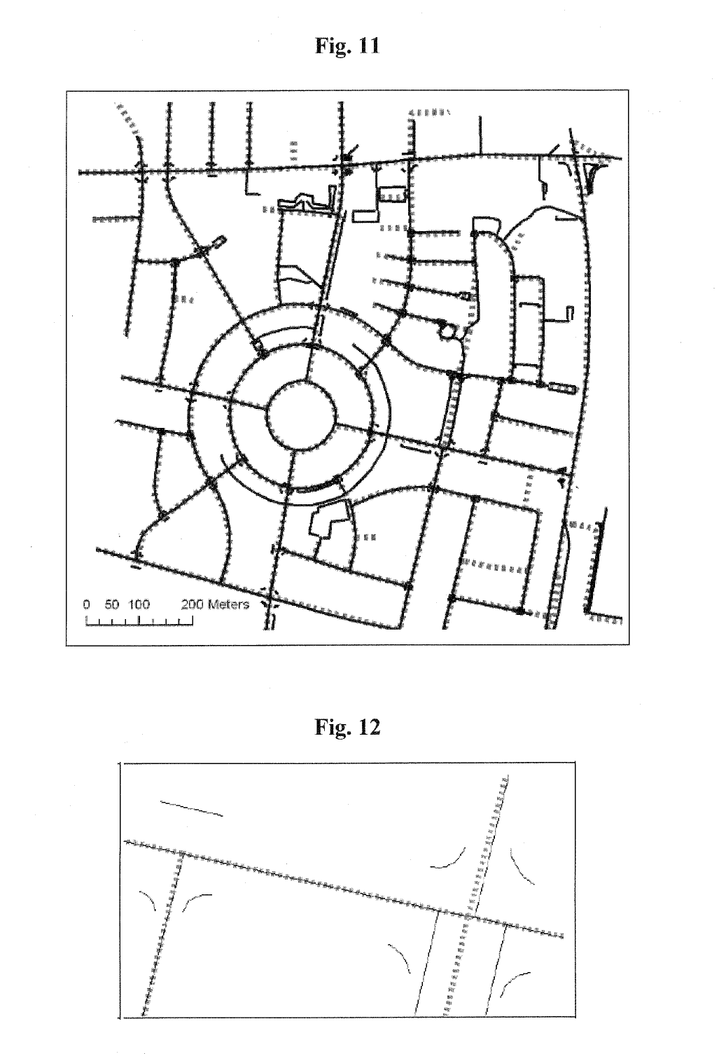

We extracted from LION and CUGIR the part which represents Manhattan and used it for the tests. The dataset we extracted from LION contains 1141 polylines. The dataset we extracted from CUGIR contains 555 polylines. Fragments of the maps are presented in FIG. 10.

In Table 1, we show for each of the six variants of the algorithm, the number of nodes that were created from each dataset. Also, we present the number of pairs of corresponding nodes that were found in the second step of the algorithm. The algorithm results were compared to a correct matching, i.e. a matching that was determined manually by a human expert. The correct matching consists of 865 join sets: 752 pairs and 113 singletons having total lengths of 87,651 and 5,933 meters, respectively.

TABLE 1
The number of nodes and the number of pairs of nodes
in the New York datasets

| | Number of nodes | Number of nodes | |
|---|---|---|---|
| | in SOI | in MAPA | Number of pairs |
| AND 1 | 353 | 255 | 66 |
| OR 1 | | | 72 |
| AND 2 | 356 | 261 | 83 |
| OR 2 | | | 150 |
| AND 3 | 386 | 291 | 91 |
| OR 3 | | | 168 |

5.1.2 Tel-Aviv datasets. A second pair of datasets that we used in the tests was extracted from road maps of the city Tel Aviv. One dataset was collected by the Survey of Israel available from Research Dept. Survey of Israel, Lincoln 1 st. Tel Aviv 65220, Israel (or on the Internet at http://www.mapi.gov.il/), and we refer to it as SOI. This dataset was extracted from aerial photographs at the scale of 1:40,000 (equivalent to digital maps at the scale of 1:5,000-1:10,000). The other dataset we used was collected by a commercial corporation, which we refer to as MAPA. This dataset was extracted directly from a digital map, at the scale of 1:25,000, by Mapa, a subsidiary of ITURAN Israel Ltd. of 3 Hashikma Street, Azuor 58001, Israel. The dataset of SOI contains 404 polylines. The dataset of MAPA contains 165 polylines.

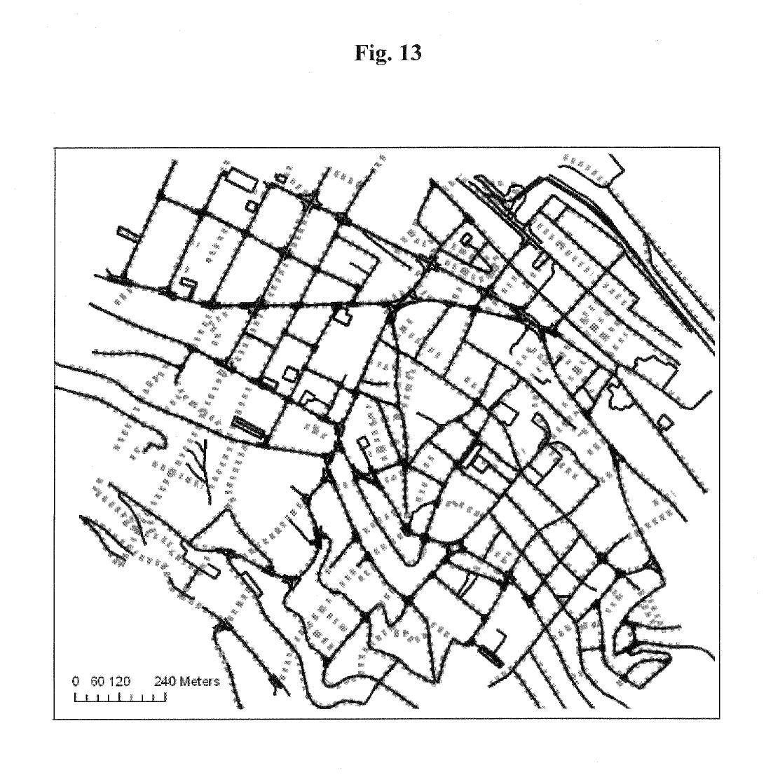

Part of the test area can be seen in FIG. 11. Although the two maps have a similar scale, there is a large difference in how they describe the same road network. The reason for the large difference is that while SOI is oriented to the generation of maps and other geometric measurements, MAPA is used mainly for road navigation. To illustrate the difficulties this difference may cause during an integration, FIG. 12 shows a small vicinity with two junctions. It can be seen that SOI has some isolated polylines while in MAPA all the polylines form a connected network.

In Table 2 we show for each of the six variants of the algorithm, the number of nodes that were created from each dataset (in the first step of the algorithm) and the number of corresponding pairs, of nodes, that were found in the second step. The correct matching that we determined manually consists of 274 join sets: 204 pairs and 70 singletons, having total lengths of 14,483 and 4,934 meters, respectively.

Determining the correct joins sets was not always straightforward. For example, in FIG. 12, it is not clear if the short roads from SOI should be matched to zero, one or two objects of MAPA. In such cases, the objects were not included in any correct join set and, in the result; join sets containing these objects were ignored.

TABLE 2
The number of nodes and the number of pairs of nodes
in the Tel-Aviv datasets

| | Number of nodes | Number of nodes | |
|---|---|---|---|
| | in SOI | in MAPA | Number of pairs |
| AND 1 | 100 | 83 | 67 |
| OR 1 | | | 84 |
| AND 2 | 513 | 111 | 93 |
| OR 2 | | | 451 |
| AND 3 | 545 | 124 | 101 |
| OR 3 | | | 486 |

5.1.3 Haifa datasets. We used the SOI and MAPA data sources for tests on maps of the city Haifa. For Haifa, the dataset of SOI contains 724 polylines, and the dataset of MAPA contains 640 polylines. Differently from New York and Tel Aviv, Haifa is located in a hilly area. Thus, the roads in Haifa are more curved than in the other two cities, and the maps of Haifa are somewhat more chaotic than the maps of New York or Tel Aviv. (See FIG. 13 for a visual view of the maps.) This increases the intricacy of the integration.

Table 3 shows, for each of the six variants of the algorithms, the number of nodes that were created from each dataset (in the first step of the algorithm) and the number of corresponding pairs of nodes that were found in the second step. The manually-determined correct matching consists of 720 join sets: 484 pairs and 236 singletons having total lengths of 32,766 and 19,042 meters, respectively.

TABLE 3
The number of nodes and the number of pairs of nodes
in the Haifa datasets

| | Number of nodes | Number of nodes | |
|---|---|---|---|
| | in SOI | in MAPA | Number of pairs |
| AND 1 | 343 | 236 | 166 |
| OR 1 | | | 241 |
| AND 2 | 888 | 423 | 233 |
| OR 2 | | | 779 |
| AND 3 | 905 | 458 | 248 |
| OR 3 | | | 821 |

5.1.4 The error factors of the sources. First, we consider the error factors of the New-York datasets. The map of TIGER is of scale 1/24,000. We assume a standard error of 0.25 mm in the map. According to the scale, we get a standard deviation σ of 6 meters in the real-world. Thus, the error factor is m=2.5σ=15 meters. For LION the only information we have is that the accuracy of the data has been gained by spatially aligning the features of the map with an aerial photography. We assumed from the detail level of the map that the aerial photography is of the same scale as in TIGER. Using such photography, a map of scale 1/5,000- 1/10,000 is produced. So, we estimated a scale of 1/7,500. With that scale, an error of 0.25 mm in the map yields an error of 1.88 meters in the real-world. Since the map was aligned with the photography and was not produced by a direct mapping of features to the photography, we increased the error by a factor of 2. So, we used σ of 3.76 meters, and an error factor m=2.5σ that is equal to 9.4 meters. Therefore, the mutual error bound for TIGER and LION is β=\sqrt{15²+9.4²}=17.7 meters.

For the datasets of Tel-Aviv and Haifa, we used the following error factors. SOI is provided with a specified σ of 2 meters; hence, the error factor m is 5 meters. MAPA was digitized from a map of scale 1/25,000. We assume a standard error of 0.25 mm in the map and the digitization process adds to the error another 0.2 mm. So, the error in the map is \sqrt{0.25²+0.2²}=0.32 mm. Having the scale of 1/25,000, the standard deviation σ of the error in the world is 8 meters. The error factor m is 2.5σ, that is, 20 meters. Now, with an error factor of 5 meters in one source and an error factor of 20 meters in the other source, β=\sqrt{5²+20²}=20.6 meters.

In order to verify our calculations, we conducted our tests using several different error factors, in addition to error factors that are presented in this section. In all our tests, using the different error factors never provided better results than when using the error factors we presented here.

### 5.2 Test Results

We present now the results of our experiments over the road maps of New York, Tel Aviv and Haifa. In Section 5.3 we will explain and analyze these results.

TABLE 4
The number of join sets in the result
and the number of correct join sets (New York)

| | Pairs in | Singletons in | Correct | Correct |
|---|---|---|---|---|
| | the Result | the Result | Pairs | Singletons |
| AND 1 | 651 | 161 | 647 | 101 |
| OR 1 | 721 | 115 | 684 | 92 |
| AND 2 | 651 | 161 | 647 | 101 |
| OR 2 | 724 | 111 | 687 | 92 |
| AND 3 | 650 | 156 | 646 | 103 |
| OR 3 | 734 | 90 | 693 | 84 |

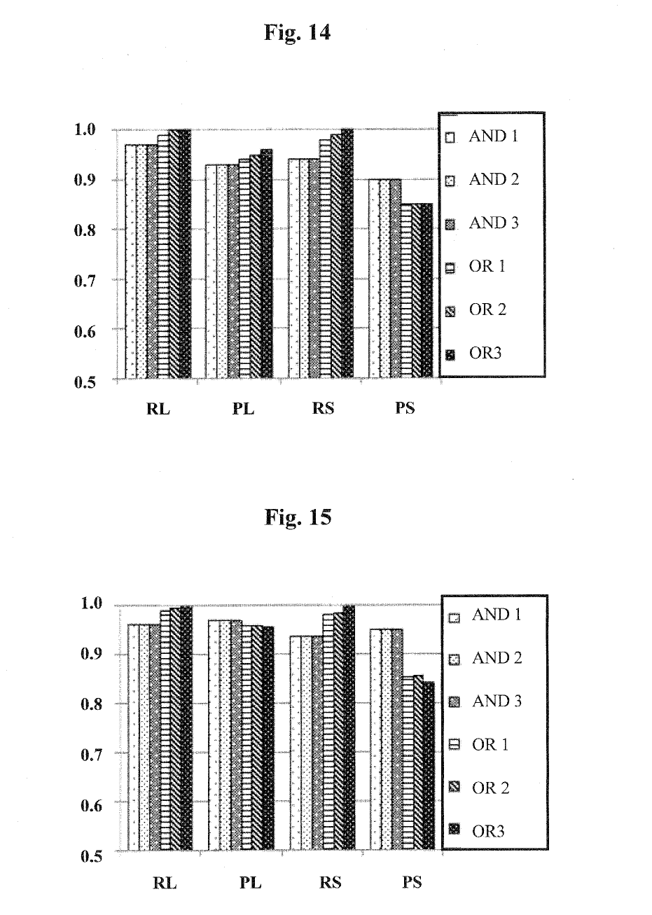

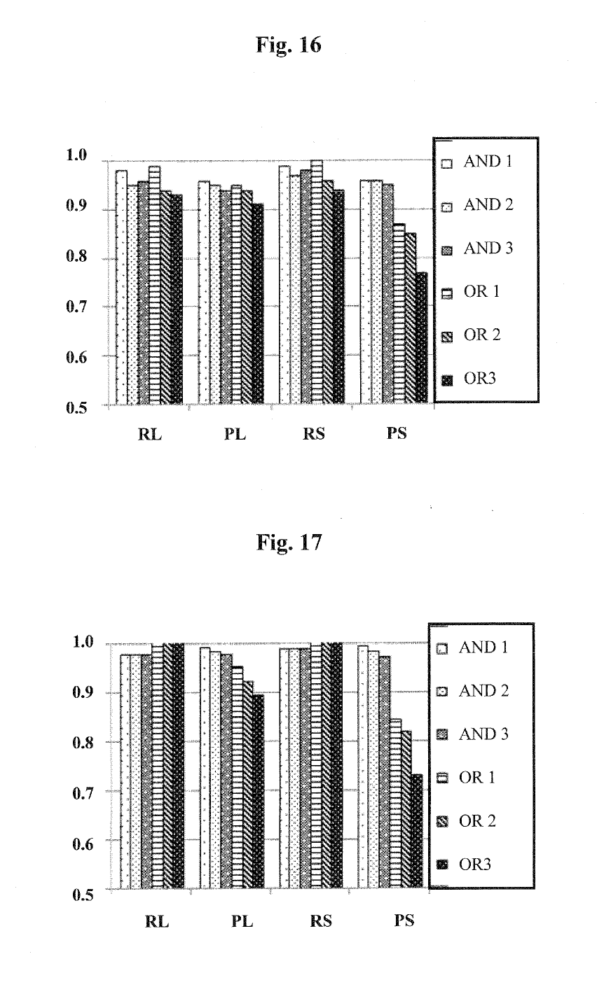

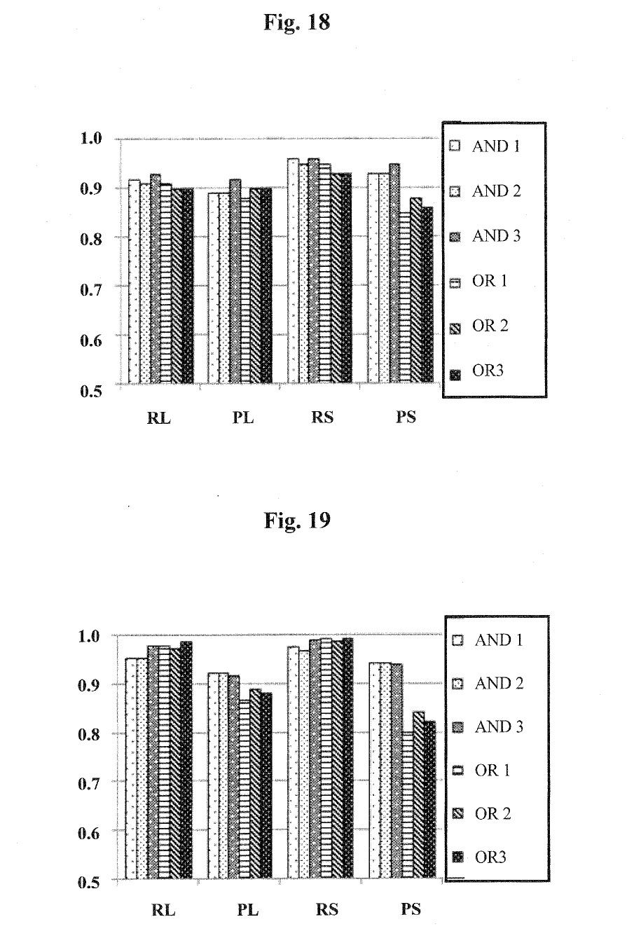

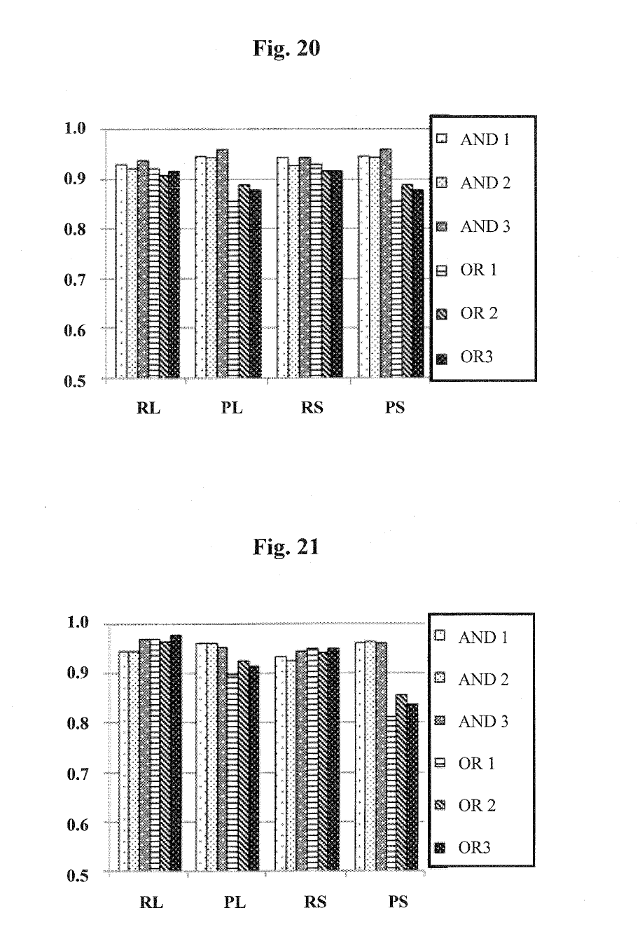

Table 4, Table 7 and Table 10 show, for each city, the numbers of pairs and singletons that were produced in the integration, and the numbers of the correct join sets. Table 5, Table 8, Table 11, FIG. 14, FIG. 16 and FIG. 18 present the recall and precision of each algorithm, using the two methods for measuring the quality of the result (FIG. 20 presents the case when dealing with anomalies). Table 6, Table 9, Table 12, FIG. 15, FIG. 17 and FIG. 19 also show the recall and precision of each algorithm, however, only for pairs; that is, each matching consists of merely pairs and the singletons are ignored (FIG. 21 presents the case when dealing with anomalies).

Next, we will show what is the influence on the results of the modifications presented in Section 3.5, for dealing with length anomalies. There were no length anomalies during the integration of the New-York datasets or during the integration of the Tel-Aviv datasets. Thus, we only show the effect of the modifications in tests over the Haifa datasets.

Over the Haifa datasets, length anomalies caused ten incorrect matches having a total length of 1345 meters. When we applied our techniques to deal with the anomalies, these erroneous matches were removed from the result. Accordingly, ten singletons were added to the result with a total length of 1694 meters. The results of the algorithms, when dealing with length anomalies, are shown in Table 13 and Table 14. Note that when considering pairs and singletons, both recall and precision are improved by the modifications. Yet, when considering only pairs, just the precision is improved since merely removing pairs cannot increase the recall.

TABLE 5
Recall and precision (New York)

| | | Precision | | |
|---|---|---|---|---|
| | Recall Length | Length | Recall Sets | Precision Sets |
| AND 1 | 0.92 | 0.95 | 0.86 | 0.92 |
| OR 1 | 0.95 | 0.97 | 0.90 | 0.93 |
| AND 2 | 0.92 | 0.95 | 0.86 | 0.92 |
| OR 2 | 0.95 | 0.98 | 0.90 | 0.93 |
| AND 3 | 0.92 | 0.96 | 0.87 | 0.93 |
| OR 3 | 0.95 | 0.99 | 0.90 | 0.94 |

TABLE 6
Recall and precision, pairs (New York)

| | | Precision | | |
|---|---|---|---|---|
| | Recall Length | Length | Recall Sets | Precision Sets |
| AND 1 | 0.92 | 1.00 | 0.86 | 1.00 |
| OR 1 | 0.95 | 0.99 | 0.91 | 0.95 |
| AND 2 | 0.92 | 1.00 | 0.86 | 1.00 |
| OR 2 | 0.96 | 0.99 | 0.91 | 0.95 |
| AND 3 | 0.92 | 1.00 | 0.86 | 1.00 |
| OR 3 | 0.96 | 0.99 | 0.92 | 0.94 |

TABLE 7
The number of join sets in the result
and the number of correct join sets (Tel-Aviv)

| | Pairs in | Singletons in | Correct | Correct |
|---|---|---|---|---|
| | the Result | the Result | Pairs | Singletons |
| AND 1 | 187 | 79 | 186 | 69 |
| OR 1 | 225 | 72 | 190 | 67 |
| AND 2 | 189 | 73 | 186 | 65 |
| OR 2 | 235 | 55 | 193 | 54 |
| AND 3 | 191 | 76 | 186 | 67 |
| OR 3 | 264 | 50 | 193 | 49 |

TABLE 8
Recall and precision (Tel-Aviv)

| | Recall | Precision | Recall | Precision |
|---|---|---|---|---|
| | Length | Length | Sets | Sets |
| AND 1 | 0.98 | 0.96 | 0.99 | 0.96 |
| OR 1 | 0.99 | 0.95 | 0.99 | 0.87 |
| AND 2 | 0.95 | 0.95 | 0.97 | 0.96 |
| OR 2 | 0.94 | 0.94 | 0.96 | 0.85 |
| AND 3 | 0.96 | 0.94 | 0.98 | 0.95 |
| OR 3 | 0.93 | 0.91 | 0.94 | 0.77 |

TABLE 9
Recall and precision pairs
(Tel-Aviv)

| | Recall | Precision | Recall | Precision |
|---|---|---|---|---|
| | Length | Length | Sets | Sets |
| AND 1 | 0.98 | 0.99 | 0.99 | 0.99 |
| OR 1 | 0.99 | 0.95 | 0.99 | 0.84 |
| AND 2 | 0.98 | 0.99 | 0.99 | 0.98 |
| OR 2 | 0.99 | 0.92 | 0.99 | 0.82 |
| AND 3 | 0.98 | 0.98 | 0.99 | 0.97 |
| OR 3 | 0.99 | 0.90 | 0.99 | 0.73 |

TABLE 10
The number of join sets in the result and the number of correct
join sets (Haifa)

| | Pairs in | Singletons in | Correct | Correct |
|---|---|---|---|---|
| | the Result | the Result | Pairs | Singletons |
| AND 1 | 479 | 237 | 452 | 217 |
| OR 1 | 575 | 207 | 460 | 201 |
| AND 2 | 474 | 234 | 448 | 211 |
| OR 2 | 543 | 199 | 457 | 193 |
| AND 3 | 468 | 220 | 458 | 211 |
| OR 3 | 558 | 195 | 460 | 191 |

TABLE 11
Recall and precision (Haifa)

| | Recall | Precision | Recall | Precision |
|---|---|---|---|---|
| | Length | Length | Sets | Sets |
| AND 1 | 0.92 | 0.89 | 0.96 | 0.93 |
| OR 1 | 0.91 | 0.89 | 0.95 | 0.93 |
| AND 2 | 0.91 | 0.89 | 0.95 | 0.93 |
| OR 2 | 0.90 | 0.90 | 0.93 | 0.88 |
| AND 3 | 0.93 | 0.92 | 0.96 | 0.95 |
| OR 3 | 0.90 | 0.90 | 0.93 | 0.86 |

TABLE 12
Recall and precision
pairs (Haifa)

| | Recall | Precision | Recall | Precision |
|---|---|---|---|---|
| | Length | Length | Sets | Sets |
| AND 1 | 0.95 | 0.92 | 0.98 | 0.94 |
| OR 1 | 0.98 | 0.87 | 0.99 | 0.89 |
| AND 2 | 0.95 | 0.92 | 0.97 | 0.95 |
| OR 2 | 0.98 | 0.89 | 0.99 | 0.84 |
| AND 3 | 0.98 | 0.92 | 0.99 | 0.94 |
| OR 3 | 0.99 | 0.88 | 0.99 | 0.82 |

TABLE 13
Recall and precision of the result
when dealing with anomalies (Haifa)

| | Recall | Precision | Recall | Precision |
|---|---|---|---|---|
| | Length | Length | Sets | Sets |
| AND 1 | 0.93 | 0.95 | 0.94 | 0.95 |
| OR 1 | 0.92 | 0.86 | 0.93 | 0.86 |
| AND 2 | 0.92 | 0.94 | 0.93 | 0.94 |
| OR 2 | 0.91 | 0.89 | 0.92 | 0.89 |
| AND 3 | 0.94 | 0.96 | 0.94 | 0.96 |
| OR 3 | 0.92 | 0.88 | 0.92 | 0.88 |

TABLE 14
Recall and precision
considering just pairs, when
dealing with anomalies (Haifa)

| | Recall | Precision | Recall | Precision |
|---|---|---|---|---|
| | Length | Length | Sets | Sets |
| AND 1 | 0.95 | 0.96 | 0.93 | 0.96 |
| OR 1 | 0.97 | 0.90 | 0.95 | 0.81 |
| AND 2 | 0.94 | 0.96 | 0.93 | 0.97 |
| OR 2 | 0.97 | 0.93 | 0.94 | 0.86 |
| AND 3 | 0.97 | 0.96 | 0.95 | 0.96 |
| OR 3 | 0.98 | 0.92 | 0.95 | 0.84 |

### 5.3 Result Analysis

In this section, first, we discuss to the results of the basic algorithms, and then we will explain the effect of the modifications for dealing with length anomalies.

5.3.1 Results of the basic algorithm. The analysis is according to the three steps of the algorithm.

Step 1—As expected, in all the tests, the number of nodes satisfying Condition II (counting nodes where the degree is either equal to 1 or greater than 2) is larger than the number of nodes satisfying Condition I (counting only nodes of degree greater than 2) and, similarly, the number of nodes satisfying Condition III (counting nodes of any degree) is larger then the number of nodes satisfying Condition II.

However, in the Tel-Aviv datasets and in the Haifa datasets (see Table 2 and Table 3), there is a greater percentage of nodes satisfying Condition I than in the New-York dataset (see Table 1). This indicates that the New-York road maps are highly connected, while in SOI and MAPA many lines are not connected to the network.

Step 2—One can see that the percentage of the lines of LION that were matched to lines of CUGIR is greater than the percentage of lines of MAPA that were matched to lines of SOI. This indicates that the similarity of LION to CUGIR is greater than the similarity of MAPA to SOI.

Step 3—In most cases, the recall and precision were higher when we used the length measure than when using the set measure. This is because many erroneous matches involve relatively short objects.

In all the tests, the use of the or semantics leads to generating many pairs while using the and semantics increases the number of singletons. Thus, when counting only pairs, the or semantics provides a high recall but a low precision. When counting also singletons this is not always the case. The reason for this is that finding more pairs decreases the number of singletons, so the recall may decrease (because correct singletons may not be found) and the precision may increase (because fewer incorrect singletons are present in the result).

Analyzing the effect of using the three conditions is more intricate. It may seem that adding nodes to the first step of the process (by using Condition II and Condition III) would result in finding more pairs of lines and thus, when counting only pairs, will increase the recall and will decrease the precision. So, Condition I should provide the largest precision and the lowest recall. Similarly, Condition III should provide the lowest precision and the highest recall. This was the case in some of the tests (for example, when using the New-York datasets) but not in all the tests.

One reason for having a higher recall when using Condition II than when using Condition III is due to the way the number of pairs are counted in a matching performed by a human. The following example illustrates such a case.

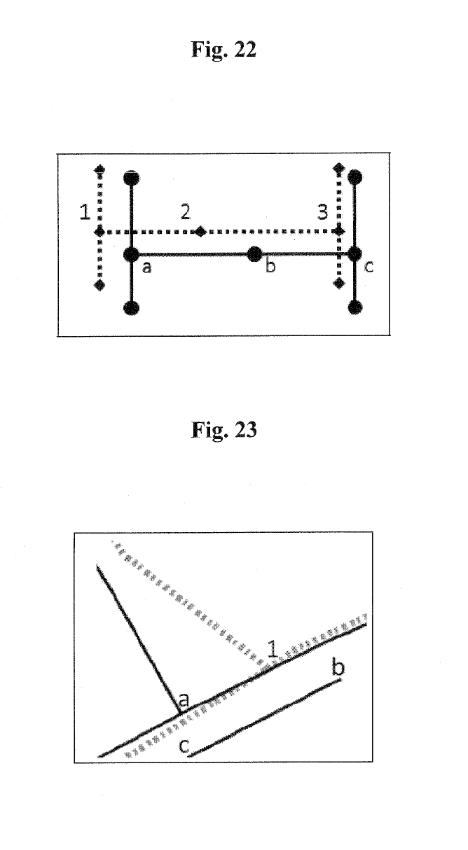

Example 5.1—Consider the lines in FIG. 22. Node 2 and Node b have a degree of two. So, under Condition II these nodes are being ignored when computing the matching of the nodes. Under Condition III these points are being considered. Thus, the output when using Condition II contains three pairs of partial overlap ({1-2, a-b}, {2-3, a-b}, {2-3, b-c}), while when using Condition III the result contains two pairs of complete overlap ({1-2, a-b}, {2-3, b-c}). When defining the ground true result (the matching generated by a human) we consider this instance as three matches. Hence, in this case the recall gained when using Condition III is lower than when using Condition II.

Actually, the case in this example occurred rarely in our datasets. In all our tests there were less than ten such cases.

Adding nodes to the datasets does not necessarily increase the recall. Since we match nodes to their nearest neighbors, two matching nodes may cease to be matching when new nodes are added. So, the addition of nodes may discard correct pairs, and thus, may reduce the recall. The following example illustrates this.

Example 5.2—Consider the networks in FIG. 23. Node b does not satisfy Condition I. Thus, when Condition I is used, the algorithm matches Node a and Node 1. When either Condition II or Condition III is used, Node b is also considered, and hence, the algorithm matches Node 1 and Node b. So, under the and semantics, the pair consisting of Node a and Node 1 is not generated.

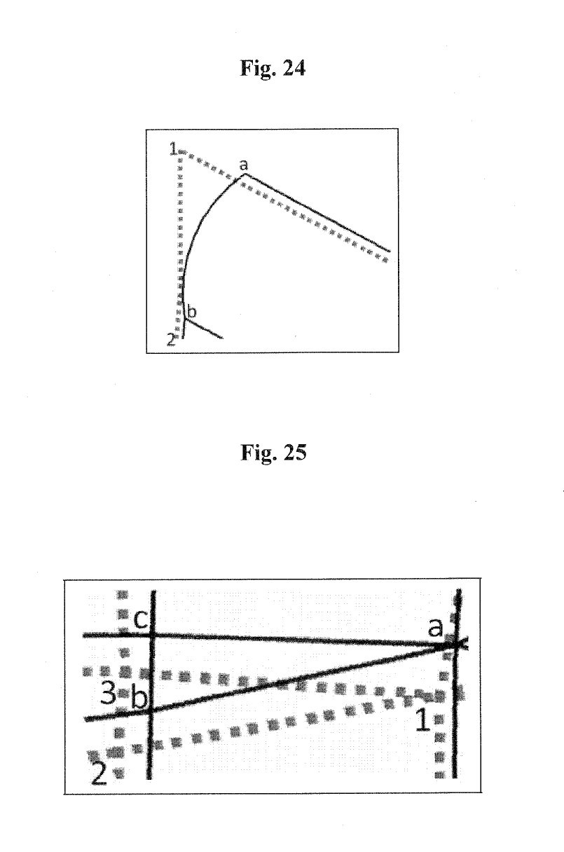

5.3.2 Dealing with length anomalies. In our tests, dealing with length anomalies improved the test results, over the Haifa datasets, by increasing the precision in almost 2%, helping to gain a precision of 96%-98% (see Table 14). We could not find any additional general cases of dealing with anomalies that could further improve the precision of our algorithms. Our algorithms did not reach a precision of 100% mainly due to uncertainty caused by inaccurate locations of nodes. FIG. 24 and FIG. 25 show two examples of uncertainty.

5.3.3 Using node degree. In Section 3.6 we presented the optional step of removing, prior to computing the matching of the lines, pairs of nodes that do not have the same node degree. The level of flexibility in the removal can be controlled by the use of a threshold. When the threshold is equal to zero, all the pairs in which nodes do not have the same degree, are discarded. When the threshold is some k≧1, we do not discard pairs of nodes that the difference between their degrees is less than or equal to k, but we do discard pairs that the difference between their degree exceeds k. In general, an increase in the size of the threshold yields an increase in the flexibility. That is, as the size of the threshold grows, there tends to be less removal of pairs.

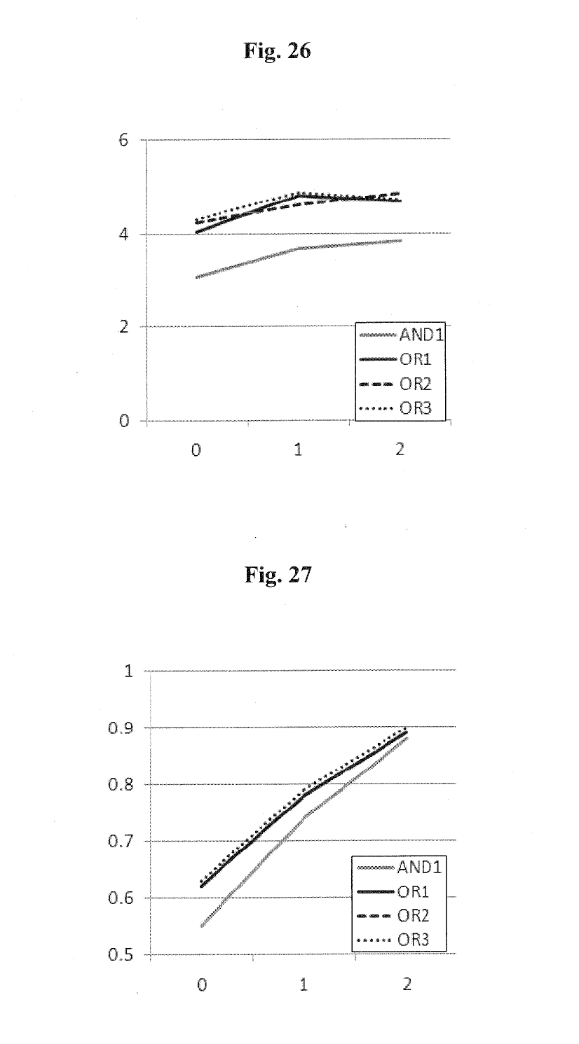

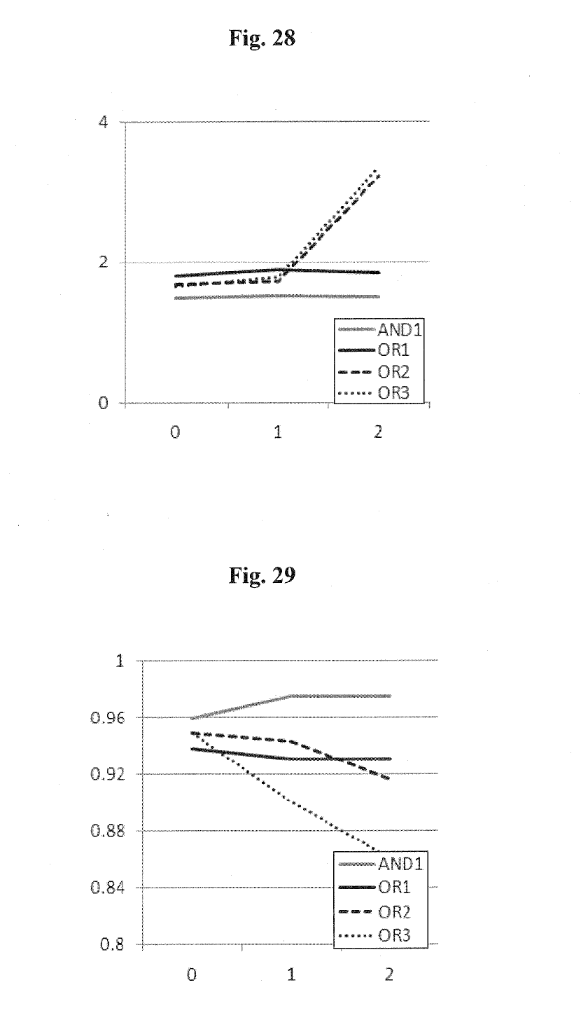

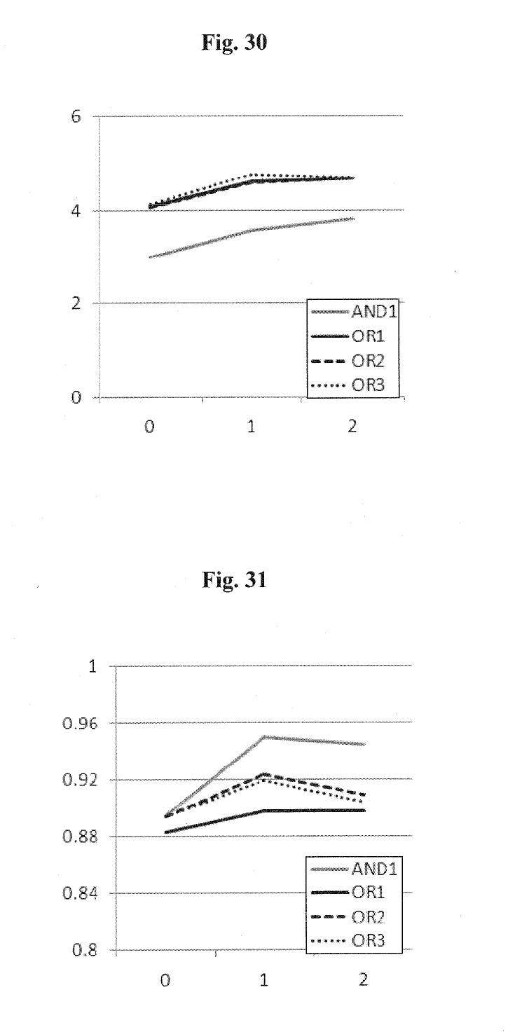

In our experiments, we tested the effect of the threshold on our algorithms. The effect of changing the threshold on the integration of the datasets is shown for the New-York datasets in FIG. 26 and FIG. 27, for the Tel-Aviv datasets in FIG. 28 and FIG. 29 and for the Haifa datasets in FIG. 30 and FIG. 31. Note that in order to simplify the presentation of the results, we used in FIG. 27, FIG. 29 and FIG. 31 the harmonic mean

$$( HRP = \frac{2 \cdot recall \cdot precision}{recall + precision} )$$

of recall and precision (abbreviated. HRP) instead of showing recall and precision separately. (In measuring the recall and precision for FIGS. 27, 29 and 31, we used the basic measure of counting the number of correct pairs and singletons.) Also note that the effect of the removal step on algorithms AND 2 and AND 3 was similar to the effect on AND 1. So, in order to improve the readability of the graphs, the lines of AND 2 and AND 3 are not presented.

In all the tests, increasing the threshold yielded an increase in the running time of the algorithms. The reason to this is obvious. Having less pairs of nodes in the result of the first stage of the algorithms reduces the work in the stage of matching the lines. Note that the effect of increasing the threshold is larger under the or-semantics than under the and-semantics. This is because more incorrect pairs are produced under the or-semantics (especially in or 2 and or 3) than under the and-semantics.

For the New-York datasets, increasing the threshold always increased the HRP. This is because these datasets are accurate but incomplete. Consequently, the matching produced many correct pairs that their node degrees were different. Removing those pairs reduced the recall and, thus, reduced the HRP.

For the Tel-Aviv and the Haifa datasets, discarding pairs that have a degree difference greater than one improved the quality of the matching. Evidently, there are more such pairs under the OR semantics than under the AND semantics. Thus, the removal has a greater effect on algorithms OR 2 and OR 3 than on AND 1. In the tests over the Haifa datasets, removing pairs that have a degree difference equal to one reduced the HRP in all the algorithms. This is because over these datasets, the algorithms produced many correct pairs that have a degree difference of one.

### 5.4 Running Times

The execution times of our algorithms on the datasets that were described earlier are shown in Table 15.

TABLE 15
Running times, in seconds, of the tests on Tel-Aviv,
Haifa and New-York.

| | Tel-Aviv | | | Haifa | | | New York | | |
|---|---|---|---|---|---|---|---|---|---|
| | (569 objects) | | | (1364 objects) | | | (1349 objects) | | |
| Stage | 1 | 2 | 3 | 1 | 2 | 3 | 1 | 2 | 3 |
| AND 1 | 0.2 | 0.03 | 1.73 | 0.09 | 0.14 | 6.25 | 0.16 | 0.25 | 4.98 |
| OR 1 | | | 1.96 | | | 7.07 | | | 4.98 |
| AND 2 | | 0.17 | 1.64 | | 0.70 | 5.80 | | 0.25 | 4.98 |
| OR 2 | | | 5.11 | | | 10.75 | | | 4.70 |
| AND 3 | | 0.20 | 1.49 | | 0.75 | 5.90 | | 0.34 | 3.20 |
| OR 3 | | | 5.14 | | | 11.75 | | | 5.14 |

For each city, the first column presents the time of the first step—retrieving the objects and creating the data structures Lₚₒᵢₙₜ and L_{polyline} that were described in Section 3.4. The second column shows the time of the second step, which is, matching the topological nodes. The third column presents the time that was required for actually matching the lines. The experiments were conducted on a PC having a Core 2 Duo processor of 2.13 GHz (E6400) and 2 GB of main memory. Note that for datasets with several hundreds of objects, the algorithms and especially AND 3, complete their task within a few seconds. For comparison, in Walter and Fritsch (1999) the matching of two datasets-one with 363 objects and the other with 435 objects—took more than two hours.

To give a sense of feeling of the execution times over large datasets, we measured the running times of our algorithms over the entire New-York datasets that were described in Section 5.1.1. These datasets contain 25,590 objects (7326 in CUGIR and 18264 in LION). The computation times of the algorithms over these datasets are shown in Table 16.

In general, the efficiency of the node-matching step can be improved by using an index that for each node provides the nearest neighbor of that node. We did not use such an index in the experiments that are presented in Table 15 because in these experiments, the running time of the second step had only a small effect on the total computation time. However, when the number of nodes is large, the node-matching step requires a large percent of the total computation time, in comparison to the case where the number of endpoints is small. Hence, in the experiments over large datasets we used a hash-based index to improve the efficiency of the node-matching step. In Table 16, we present the running times of the node-matching step, with and without the use of an index. It can be seen that using an index considerably improves the efficiency of that step.

### 7. Conclusion

We have investigated the integration of road networks from two datasets. The novelty of our approach is in developing algorithms that have high recall and precision, even though they only use endpoints of polylines. Our algorithms are much more efficient than previous algorithms for road-map integration. In addition to the algorithms and the complete set of tests, another important contribution is the framework that includes an analysis of the time and space complexities, and measures that indicate the quality of the result of integration.

Several variants of a basic algorithm were presented. Each variation uses one out of two semantics for node matching (namely, AND and OR) and one out of three node conditions. Each variation performs better under different circumstances (e.g. whether some of the roads are isolated from the main network or not) and user requirements (e.g. whether the user wants higher recall or higher precision? whether the result should include only pairs or also singletons?).

We tested the different variants of our algorithm on three different integration scenarios. We conducted the tests over four different data sources, from different vendors, consisting of the road networks of the cities New York, Tel Aviv and Haifa. Our tests show that usually the best precision is gained by using the and-semantics with Condition-I. This combination is also the most efficient, in most cases. The best recall is usually achieved by using the or-semantics with Condition-III. An exceptional case in which AND 1 does not provide the highest precision is integration where one of the networks has low connectivity. When the connectivity is low, many endpoints have a degree of 1; however, when using Condition I, the algorithm ignores such nodes. Consequently, there are many erroneous matchings of nodes and, thus, errors in the matching of the polylines. So, when connectivity is low, for high precision, and 2 should be employed.

In our tests we measured the running times of our algorithms. The tests show that, compared to earlier work, the reduction in processing time is huge (seconds instead of hours), while the quality of the results remains almost the same (i.e. a difference of only a few percentage points).

Several interesting problems remain for future work. One is to deal with other types of datasets, such as water and electricity networks. A second problem is how to present the result of the integration graphically as a new map. A third problem is how to use integration of roads to improve the quality and the efficiency of integration of maps that contain both roads and other types of data.

Though the invention has been described in detail describing an implementation of integration of roadmaps, nevertheless changes and modifications which do not depart from the teachings of the present invention will be evident to those skilled in the art. For example, the present invention can be used to integrate spatial datasets describing buildings, surface areas or any other spatial data. Such changes and modifications are deemed to come within the purview of the present invention and the appended claims.

1. A method for integrating a plurality of spatial datasets comprising a plurality of topological nodes and polylines, said method comprising the steps of:
(i) finding the topological nodes of each spatial dataset and generating a plurality of pairs, each pair consisting of a topological node and an associated polyline such that said topological node is an endpoint of said associated polyline;
(ii) matching the topological node of each generated pair in said plurality of spatial datasets with another topological node in a generated pair of a different spatial dataset, such that two topological nodes are matched if they represent the same real-world location in the corresponding spatial datasets; and
(iii) matching the polylines in said plurality of spatial datasets based on the previously matched topological nodes.

2. A method according to claim 1, wherein the step of finding the topological nodes is done as a separate preprocessing operation for each spatial dataset.

3. A method according to claim 1, wherein matching said topological nodes takes into account the mutual bound error such that two topological nodes are matched if the distance between them is not greater than the mutual bound error.

4. A method according to claim 1, wherein matching two polylines is successful if one of the following relationships between said two polylines occur:
(i) complete overlap between said two polylines;
(ii) one polylines is an extension of the second polylines;
(iii) one polylines is contained in the second polylines; and
(iv) partial overlap of said two polylines.

5. A method according to claim 1, wherein said plurality of spatial datasets are road maps.

6. A method according to claim 5, wherein said real-world location is a real-world intersection.

7. A method according to claim 1, wherein two polylines are matched either when the topological nodes associated with each polyline are matched or when at least one topological node of one polyline is an intermediate point of the other polyline.

8. A method according to claim 1, wherein a topological node of one polyline is an intermediate point of another polyline when the distance between the topological node and the other polyline is smaller than β.

9. A method according to claim 1, wherein said matching the polylines is performed by matching of polylines where at least one of the topological nodes was matched in phase ii, and then by matching of polylines with only matching intermediate points.

10. A method according to claim 1, wherein the contents of each spatial dataset are updated individually.

11. A method for integrating two spatial datasets comprising a plurality of topological nodes and polylines representing real-world roads, said method comprising the steps of:
(i) finding the topological nodes of each spatial dataset and generating a plurality of pairs, each pair consisting of a topological node and an associated polyline such that said topological node is an endpoint of said associated polyline;
(ii) matching the topological node of each generated pair in one spatial dataset with another topological node in a generated pair of the other spatial dataset, such that two topological nodes are matched if they represent the same real-world intersection in the corresponding spatial datasets; and
(iii) matching the polylines in the two spatial datasets based on the previously matched topological nodes.

12. A system for integrating a plurality of spatial datasets comprising a plurality of topological nodes and polylines, said system comprising:
(i) means for finding the topological nodes of each spatial dataset and generating a plurality of pairs, each pair consisting of a topological node and an associated polyline such that said topological node is an endpoint of said associated polyline;
(ii) means for matching the topological node of each generated pair in said plurality of spatial datasets with another topological node in a generated pair of a different spatial dataset, such that two topological nodes are matched if they represent the same real-world location in the corresponding spatial datasets; and
(iii) means for matching the polylines in said plurality of spatial datasets based on the previously matched topological nodes.

13. A system according to claim 12, wherein the step of finding the topological nodes is done as a separate preprocessing operation for each spatial dataset.

14. A system according to claim 12, wherein matching said topological nodes takes into account the mutual bound error such that two topological nodes are matched if the distance between them is not greater than the mutual bound error.

15. A system according to claim 12, wherein matching two polylines is successful if one of the following relationships between said two polylines occur:
(i) complete overlap between said two polylines;
(ii) one polylines is an extension of the second polylines;
(iii) one polylines is contained in the second polylines; and
(iv) partial overlap of said two polylines.

16. A system according to claim 12, wherein said plurality of spatial datasets are road maps.

17. A system according to claim 16, wherein said real-world location is a real-world intersection.

18. A system according to claim 12, wherein two polylines are matched either when the topological nodes associated with each polyline are matched or when at least one topological node of one polyline is an intermediate point of the other polyline.

19. A system according to claim 12, wherein a topological node of one polyline is an intermediate point of another polyline when the distance between the topological node and the other polyline is smaller than P.

20. A system according to claim 12, wherein said matching the polylines is performed by matching of polylines where at least one of the topological nodes was matched in phase ii, and then by matching of polylines with only matching intermediate points.

21. A system according to claim 12, wherein the contents of each spatial dataset are updated individually.

22. A system for integrating two spatial datasets comprising a plurality of topological nodes and polylines representing real-world roads, said system comprising:
(i) means for finding the topological nodes of each spatial dataset and generating a plurality of pairs, each pair consisting of a topological node and an associated polyline such that said topological node is an endpoint of said associated polyline;
(ii) means for matching the topological node of each generated pair in one spatial dataset with another topological node in a generated pair of the other spatial dataset, such that two topological nodes are matched if they represent the same real-world intersection in the corresponding spatial datasets; and
(iii) means for matching the polylines in the two spatial datasets based on the previously matched topological nodes.

23. A computer-readable medium encoded with a program module that integrates a plurality of spatial datasets comprising a plurality of topological nodes and polylines, by:
(i) finding the topological nodes of each spatial dataset and generating a plurality of pairs, each pair consisting of a topological node and an associated polyline such that said topological node is an endpoint of said associated polyline;
(ii) matching the topological node of each generated pair in said plurality of spatial datasets with another topological node in a generated pair of a different spatial dataset, such that two topological nodes are matched if they represent the same real-world location in the corresponding spatial datasets; and
(iii) matching the polylines in said plurality of spatial datasets based on the previously matched topological nodes.

24. A medium according to claim 23, wherein the step of finding the topological nodes is done as a separate preprocessing operation for each spatial dataset.

25. A medium according to claim 23, wherein matching said topological nodes takes into account the mutual bound error such that two topological nodes are matched if the distance between them is not greater than the mutual bound error.

26. A medium according to claim 23, wherein matching two polylines is successful if one of the following relationships between said two polylines occur:
(i) complete overlap between said two polylines;
(ii) one polylines is an extension of the second polylines;
(iii) one polylines is contained in the second polylines; and
(iv) partial overlap of said two polylines.

27. A medium according to claim 23, wherein said plurality of spatial datasets are road maps.

28. A medium according to claim 27, wherein said real-world location is a real-world intersection.

29. A medium according to claim 23, wherein two polylines are matched either when the topological nodes associated with each polyline are matched or when at least one topological node of one polyline is an intermediate point of the other polyline.

30. A medium according to claim 23, wherein a topological node of one polyline is an intermediate point of another polyline when the distance between the topological node and the other polyline is smaller than β.

31. A medium according to claim 23, wherein said matching the polylines is performed by matching of polylines where at least one of the topological nodes was matched in phase ii, and then by matching of polylines with only matching intermediate points.

32. A medium according to claim 23, wherein the contents of each spatial dataset are updated individually.

33. A computer-readable medium encoded with a program module that integrates two spatial datasets comprising a plurality of topological nodes and polylines representing real-world roads, by:
(i) finding the topological nodes of each spatial dataset and generating a plurality of pairs, each pair consisting of a topological node and an associated polyline such that said topological node is an endpoint of said associated polyline;
(ii) matching the topological node of each generated pair in one spatial dataset with another topological node in a generated pair of the other spatial dataset, such that two topological nodes are matched if they represent the same real-world intersection in the corresponding spatial datasets; and
(iii) matching the polylines in the two spatial datasets based on the previously matched topological nodes.
